(19) United States
(12) Patent Application Publication
(10) Pub. No.: US 2026/0007107 A1
(43) Pub. Date: Jan. 8, 2026

(54) BALE STACKER SYSTEM

(71) Applicant: Marcrest Manufacturing Inc., Listowel (CA)

(72) Inventors: Keith HORST, Listowel (CA); Collin ZETTLER, Listowel (CA)

(21) Appl. No.: 19/257,690

(22) Filed: Jul. 2, 2025

Related U.S. Application Data
(60) Provisional application No. 63/667,243, filed on Jul. 3, 2024.

(51) Int. Cl. A01D 85/00; A01F 15/14

(52) U.S. Cl. CPC A01D 85/005; A01F 15/141

(57) ABSTRACT

A system for forming a bale bundle that includes a preselected number of columns of bales, each column including a predetermined number of the bales. The system includes an injector for moving the predetermined number of the bales in a predetermined injection sequence into a loading chamber. In the predetermined injection sequence, the injector moves a preselected number of the bales into the chute and subsequently moves the predetermined number of the bales into the loading chamber. The system also includes a plunger assembly for moving columns of the bales positioned in succession in the loading chamber into the compression chamber in a predetermined assembly sequence, until the preselected number of the columns is in the compression chamber. The plunger assembly compresses the preselected number of columns while a knotter assembly ties the columns together to form the bale bundle, and the injector recommences the predetermined injection sequence.

### CROSS-REFERENCE TO RELATED APPLICATION

This application claims the benefit of U.S. Provisional Patent Application No. 63/667,243, filed on Jul. 3, 2024, the entirety of which provisional patent application is hereby incorporated herein by reference.

### FIELD OF INVENTION

The present invention is a system for stacking bales to form bale bundles.

### BACKGROUND OF THE INVENTION

Bale stacker machines, which secure bales together in a bundle or group, are known. For example, bale stacker machines are disclosed in U.S. Pat. Nos. 7,610,851 and 8,122,822.

In recent years, transportation of forage over relatively long distances has been economically viable due to the prices paid for good quality forage in certain areas. If the forage is to be transported over long distances, it has been found to be convenient to tie a number of individual bales together into relatively large bale bundles. The dimensions of the bale bundles are selected so that the bale bundles will fit inside a vehicle, e.g., a standard covered trailer or a known truck box. The practice of tying a number of individual bales together to form bale bundles has developed in order to permit more economical handling of the forage in connection with its storage and transportation.

In FIG. 1A, the height, length, and width of a bale 10 are identified by “H”, “L”, and “W” respectively.

In practice, the dimensions of bales vary, for example, according to geographic region. For example, in eastern North America, the bale typically is about 18 inches wide, 14 inches high, and 35 inches in length (FIG. 1A). However, in other parts of North America, the bales typically are formed with different dimensions. For example, in some areas, the bale typically has a width “W” of about 22 inches, a height “H” of about 16 inches, and a length “L” of about 36 inches.

For the purposes hereof, a bale with width, height, and length of about 18 inches, 14 inches, and 32 inches respectively is referred to as a “standard” bale, for convenience. Also, for the purposes hereof, a bale with width, height, and length of about 22 inches, 16 inches, and 36 inches respectively is referred to as a “large” bale, for convenience.

The foregoing are examples of bales that are customarily formed in certain geographic areas. As is well known in the art, in certain other geographic areas, bales may be formed with other dimensions. Also, depending on the circumstances, some bales are larger than the “large” bales described above. For example, very large square bales (e.g., 3′×3′, or 4′×4′) that may be between four feet and eight feet long may be formed.

In the usual current practice, twenty-one standard bales are stacked in seven vertical columns of three bales each and then tied together, to form a bale bundle. A typical bale bundle 12 including standard bales 10 is shown in FIG. 1B. As can be seen in FIG. 1B, the bales 10 may be positioned in columns 14 with the sidewalls of the bales facing downwardly and upwardly (or substantially downwardly and upwardly), and the columns 14 are tied together to form the bale bundle 12. The overall length of the bale bundle 12 illustrated in FIG. 1B is the height of the bale multiplied by seven, i.e., in this example, approximately 98 inches (14″×7).

As noted above, the bale bundles are formed to fit inside a standard trailer (e.g., a trailer 53 feet long) or a truck box. Depending on the size of truck box or the trailer, more than one bale bundle may be positioned in the truck trailer. Typically, the bale bundle 12 is formed so that, when the bale bundle is located in the trailer, top sides of the bales and bottom sides of the bales face the side walls of the trailer, and end walls of the bales face the end walls of the trailer. The sidewalls of the bales in the bale bundles face the floor and the top wall or ceiling of the trailer.

The “large” bales are significantly larger than the standard bales. The bale bundles that is formed of large bales preferably includes only two large bales in one column, and only six such columns in the bale bundle that is formed of large bales (not shown). Accordingly, the overall length of the bale bundle that is formed of large bales is 16 inches multiplied by six, or approximately 96 inches.

It will be understood that the twine or nylon string used to tie the bales together in the bale bundle is not shown in FIG. 1B, for clarity of illustration. As will be described, the invention is illustrated in the balance of the drawings.

The prior art machines have a number of disadvantages. For example, the prior art bale stacker machines require a relatively long time to form a bale bundle.

### SUMMARY OF THE INVENTION

For the foregoing reasons, there is a need for a bale stacker system that overcomes or mitigates one or more of the disadvantages of the prior art.

In its broad aspect, the invention provides a system for forming a bale bundle that includes a preselected number of columns of bales. Each column includes a predetermined number of the bales. The system includes an injector for moving the predetermined number of the bales in a predetermined injection sequence into a loading chamber. In the predetermined injection sequence, the injector moves a preselected number of the bales into the chute and subsequently moves the predetermined number of the bales into the loading chamber. The system also includes a plunger assembly for moving columns of the bales positioned in succession in the loading chamber into the compression chamber in a predetermined assembly sequence, until the preselected number of the columns is in the compression chamber. The plunger assembly compresses the preselected number of columns while a knotter assembly ties the columns together to form the bale bundle, and the injector recommences the predetermined injection sequence.

In another of its aspects, the invention provides a method of forming a bale bundle that includes a preselected number of columns of bales, and in which each of the columns includes a predetermined number of the bales. With an injector, when a predetermined injection sequence begins, a preselected number of the bales that is equal to the predetermined number of the bales in the column minus one is moved into a chute. In the final step of the predetermined injection sequence, the predetermined number of the bales is formed into the column that is moved into the loading chamber.

With a plunger, each of the columns of bales is moved in succession from the loading chamber into a compression chamber, in a predetermined assembly sequence. A predetermined number of columns that is equal to the preselected number of columns minus one is moved into the compression chamber by the plunger. In the final step of the predetermined assembly sequence, the preselected number of the columns of the bales is compressed in the compression chamber by the plunger for a predetermined time period, while a knotter ties the columns together to form the bale bundle. With the injector, the predetermined injection sequence recommences during the predetermined time period

### BRIEF DESCRIPTION OF THE DRAWINGS

The invention will be better understood with reference to the attached drawings, in which:

FIG. 1A (previously discussed) is an isometric view of individual bale of the prior art;

FIG. 1B (previously discussed) is a side view of a bale bundle of the prior art, drawn at a smaller scale;

FIG. 1C is a side view of an embodiment of a bale system of the invention;

FIG. 2A is a top view of the bale stacker system of FIG. 1C, drawn at a smaller scale;

FIG. 2B is a longitudinal section of the bale stacker system of FIG. 2A, taken along line A-A in FIG. 2A;

FIG. 2C is a side view of a portion of the bale stacker system of FIGS. 2A and 2B, drawn at a larger scale;

FIG. 2D is a side view of the portion shown in FIG. 2C in which an injector blade is located in its home position;

FIG. 3A is a top view of the bale stacker system, drawn at a smaller scale;

FIG. 3B is a longitudinal section of the bale stacker system of FIG. 3A, taken along line C-C in FIG. 3A;

FIG. 3C is a side view of a portion of the bale stacker system of FIGS. 3A and 3B, drawn at a larger scale;

FIG. 3D is a side view of the portion shown in FIG. 3C in which the injector blade is located in its home position;

FIG. 4A is a top view of the bale stacker system, drawn at a smaller scale;

FIG. 4B is a longitudinal section of the bale stacker system of FIG. 4A, taken along line E-E in FIG. 4A, in which a column is positioned in the loading chamber;

FIG. 4C is a side view of a portion of the bale stacker system of FIGS. 4A and 4B in which the injector blade is shown supporting the column in the loading chamber, drawn at a larger scale;

FIG. 4D is a side view of the portion shown in FIG. 4C in which the injector is shown in the home position thereof;

FIG. 5A is a top view of the bale stacker system, drawn at a smaller scale;

FIG. 5B is a longitudinal section of the bale stacker system of FIG. 5A, taken along line J-J in FIG. 5A;

FIG. 5C is a side view of a portion of the bale stacker system of FIGS. 5A and 5B, drawn at a larger scale;

FIG. 5D is a side view of a portion of the bale stacker system of FIGS. 5A-5C in which the column of the bales is in an unobstructive location;

FIG. 6A is a top view of the bale stacker system, drawn at a smaller scale;

FIG. 6B is a longitudinal section of the bale stacker system of FIG. 6A, taken along line G-G in FIG. 6A;

FIG. 6C is a side view of a portion of the bale stacker system of FIGS. 6A and 6B, drawn at a larger scale;

FIG. 7 is a block diagram illustrating a system controller of the bale stacker system and related elements;

FIG. 8A is a side view of the bale stacker system including an embodiment of a pick-up assembly of the invention, drawn at a smaller scale;

FIG. 8B is a longitudinal section of the bale stacker system and the pick-up assembly of FIG. 8A;

FIG. 8C is an isometric view of an embodiment of the pick-up assembly of the bale stacker system of FIGS. 8A and 8B, drawn at a larger scale;

FIG. 9A is a flow chart illustrating a preselected series of steps in an embodiment of a predetermined injection sequence;

FIG. 9B is a flow chart illustrating a preselected series of steps in am embodiment of a predetermined assembly sequence;

FIG. 10A is a side view of another embodiment of the pick-up assembly of the invention, drawn at a larger scale;

FIG. 10B is a top view of the pick-up assembly of FIG. 10A;

FIG. 10C is a front isometric view of the pick-up assembly of FIGS. 10A and 10B, in showing rollers positioned in left and right intake walls of the pick-up assembly;

FIG. 10D is a bottom view of the pick-up assembly of FIGS. 10A-10C;

FIG. 10E is a rear isometric view of the pick-up assembly of FIGS. 10A-10D;

FIG. 10F is a cross-section of a drive roller in the left intake wall, showing the drive roller in an inward position thereof and an outward position thereof, drawn at a larger scale;

FIG. 10G is a side view of a portion of the right intake wall showing drive rollers mounted to resilient mount subassemblies to a wall element of the right intake wall, drawn at a smaller scale;

FIG. 10H is an isometric longitudinal section of a portion of the right intake wall, the drive rollers therein, and the resilient mount subassemblies to which the drive rollers are mounted;

FIG. 10I is an isometric view of a portion of the right intake wall, the drive rollers therein, and the resilient mount subassemblies to which the drive rollers are mounted;

FIG. 10J is an isometric, interior view of the drive rollers and resilient mount subassemblies mounted in the right intake wall, from which the wall element of the right intake wall is omitted;

FIG. 10K is a top view of a spring subassembly of the resilient mount subassemblies in the right intake wall with related elements, drawn at a larger scale;

FIG. 11A is a top view of a driven roller mounted to a resilient mount subassembly in the right intake wall, showing the driven roller in an inward position thereof and an outward position thereof, drawn at a smaller scale; and

FIG. 11B is a side view of a portion of the right intake wall showing the driven roller and the resilient mount subassembly to which the driven roller is mounted.

### DETAILED DESCRIPTION

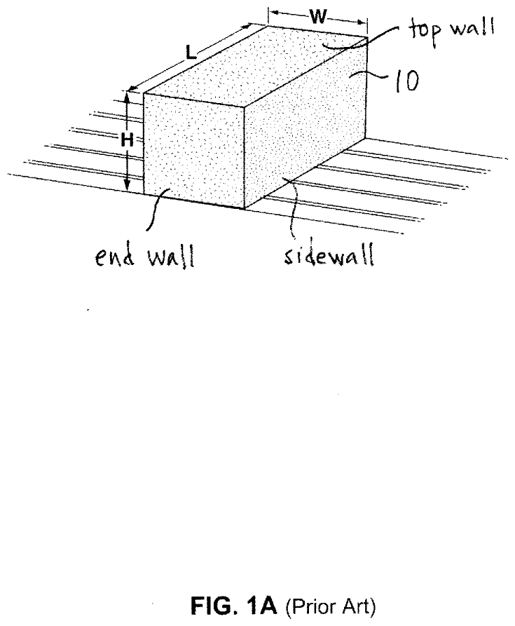

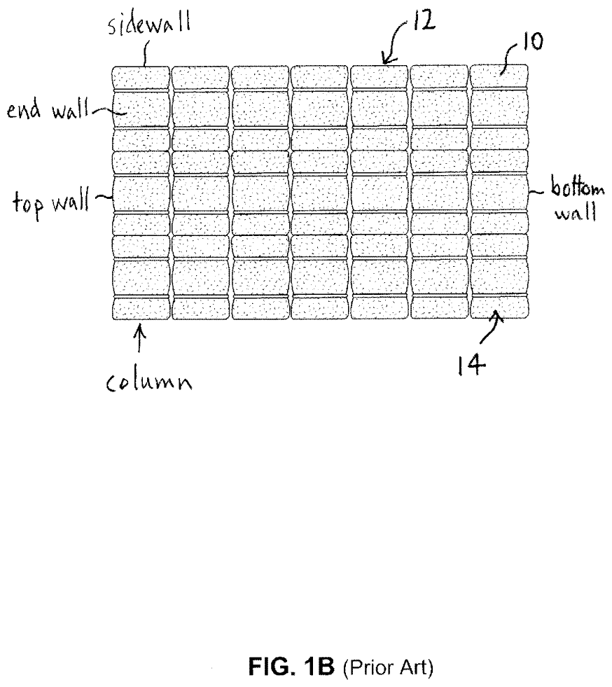

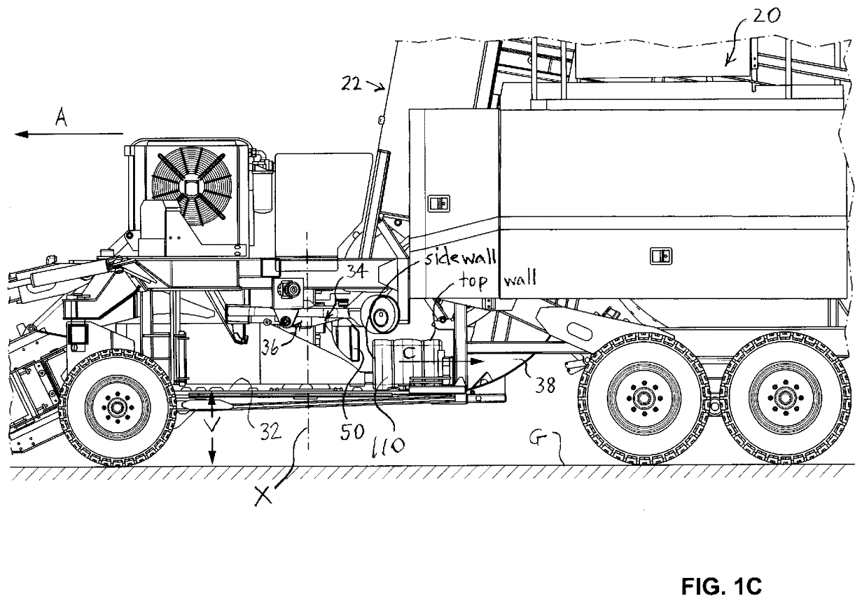

In the attached drawings, like reference numerals designate corresponding elements throughout. In particular, to simplify the description, the reference numerals previously used in FIGS. 1A and 1B are used again in connection with the description of the invention hereinafter, except that each such reference numeral is raised by 100, where the elements described correspond to elements referred to above. Reference is first made to FIGS. 1C-8C to describe an embodiment of a bale stacker system in accordance with the invention indicated generally by the numeral 20.

As will be described, the bale stacker system 20 is for forming a bale bundle 112 that includes a preselected number of columns 114 of bales 110 with preselected dimensions. Each of the columns 114 includes a predetermined number of the bales 110. Those skilled in the art would appreciate that the preselected dimensions (height, length, and width) of the bales may vary, e.g., according to geographic region.

Because the bale bundle 112 includes a preselected number of columns of a predetermined number of bales and the bales are formed to have the preselected dimensions, the bale bundle 112 has predetermined dimensions. Those skilled in the art would appreciate that, in practice, the bale bundle preferably is designed to fit into a standard truck trailer or box. However, it will be understood that the possible sizes of the bale bundle are limited according to the preselected dimensions of the bales.

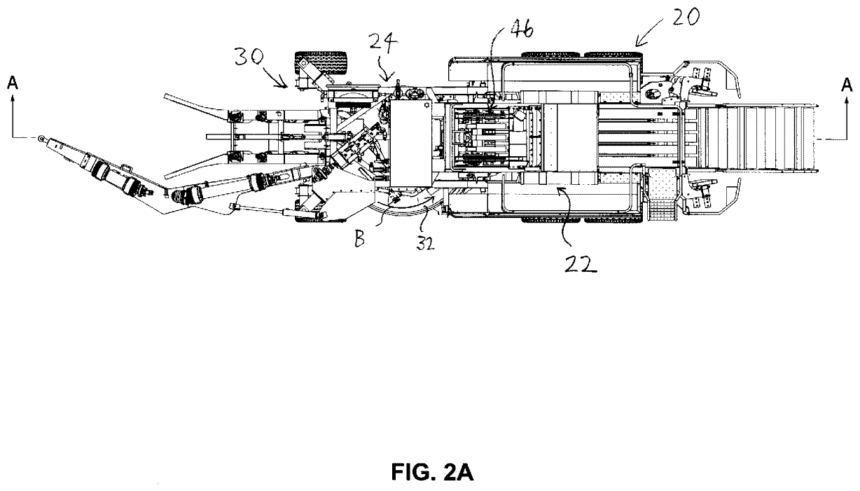

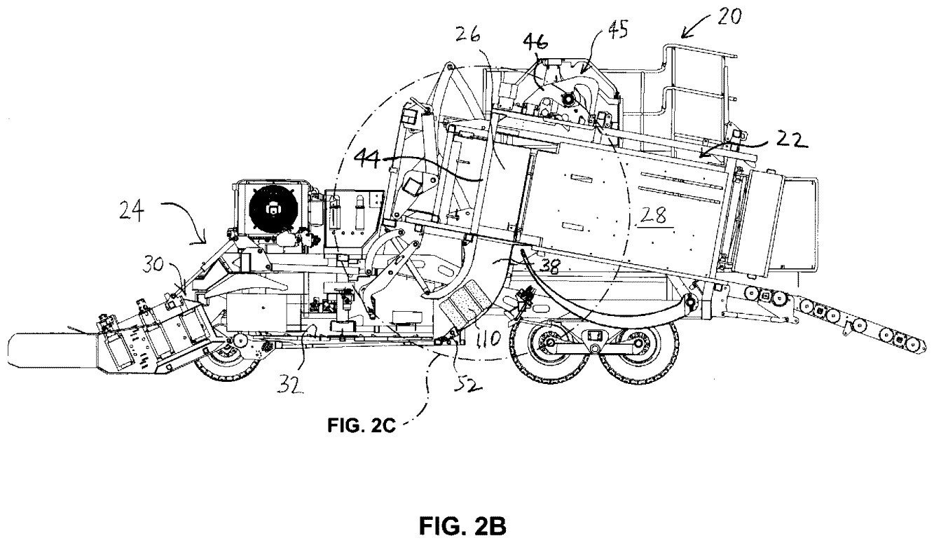

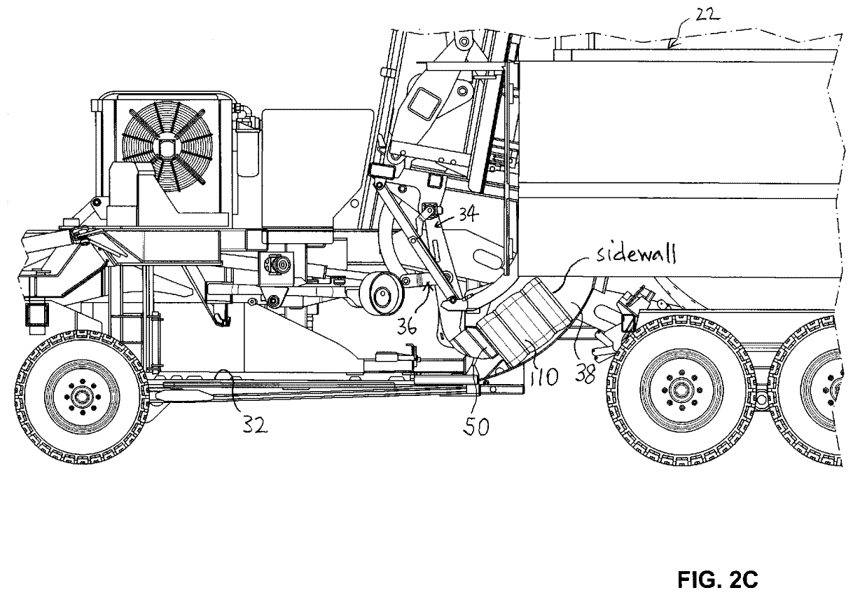

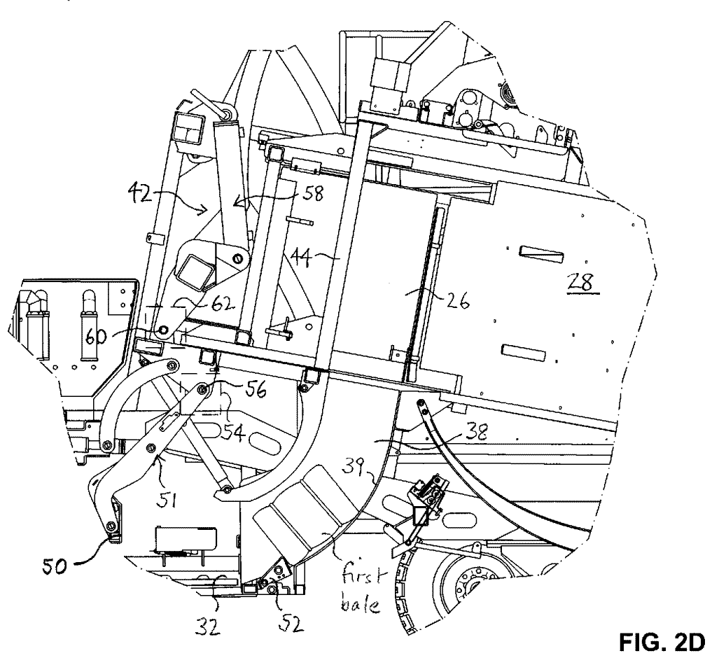

In one embodiment, the system 20 preferably includes a body assembly 22 including an intake portion 24, a loading chamber 26, and a compression chamber 28 (FIG. 2B).

Preferably, the loading chamber 26 is formed to receive the column 114. This means that the loading chamber 26 is formed to receive the predetermined number of the bales 110 in the column 114. As will be described, the compression chamber 28 is sized to receive the preselected number of columns 114 that are required to form the bale bundle 112, which has predetermined dimensions. The bale bundles 112 are individually formed in the compression chamber 28, in which the preselected number of the columns 114 of the bales 110 is receivable.

It will be understood that the bales processed by the system may have any suitable preselected dimensions, and the system may be adjusted to accommodate bales having a variety of preselected dimensions.

### Standard Bales Example—Injector

It will be understood that in the examples that are illustrated, the bales are the standard bales (as described above), and the predetermined number of the standard bales in each column is three. Also, because only examples showing standard bales are illustrated, the preselected number of columns in the illustrated bale bundle examples is seven.

As described above, those skilled in the art would appreciate that the bales may not be “standard” bales. Those skilled in the art would also appreciate that bale bundles may have different numbers of bales in each column, and/or different numbers of columns of bales in the bale bundles. It will be understood that bales and bale bundles having a variety of predetermined dimensions may be formed using embodiments of the system of the invention, if appropriate adjustments are made.

For example, as noted above, if the bales are “large” rather than “standard”, then only two large bales preferably are included in each column. Those skilled in the art would appreciate that, in those circumstances, and the bale bundle may be formed of six such columns of large bales, as will be described.

In one embodiment, the system 20 preferably includes an intake assembly 30 that is positioned in the intake portion 24 (FIG. 2B). The intake assembly 30 preferably includes a table 32, which is rotatable about an axis “X” (FIG. 1C).

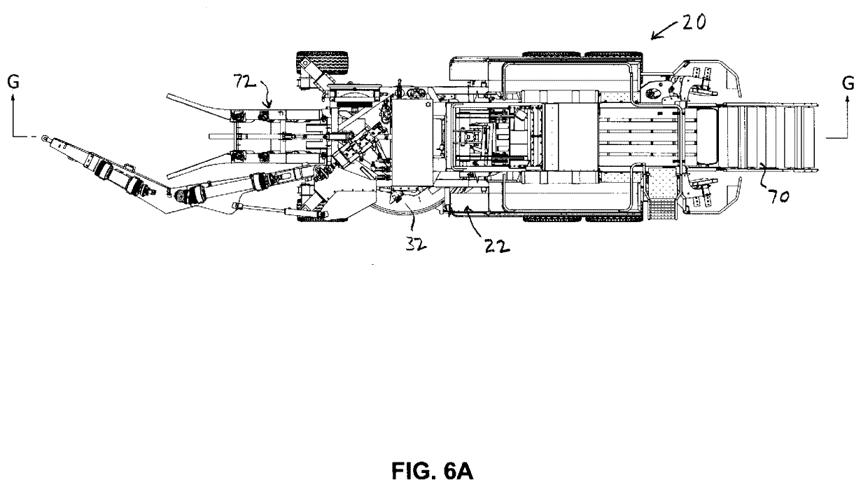

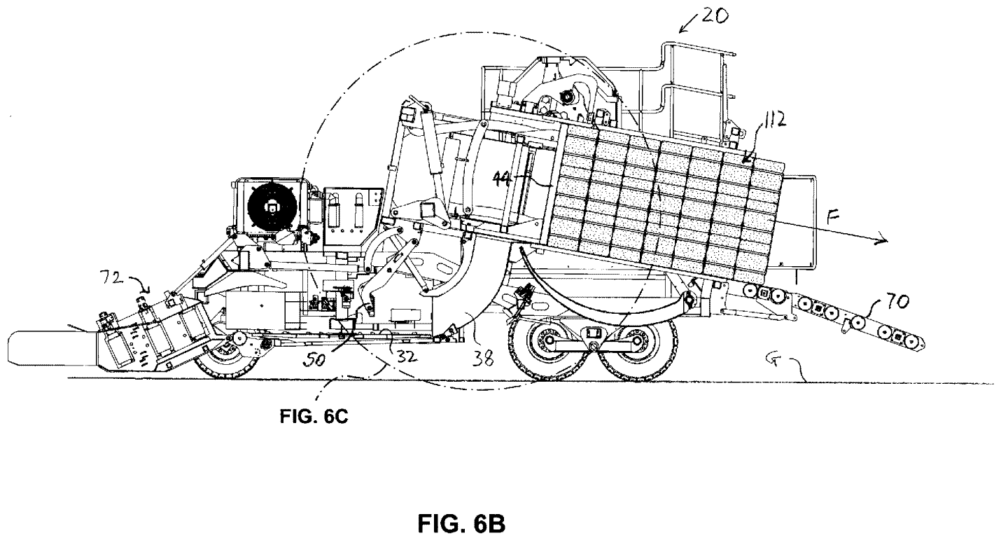

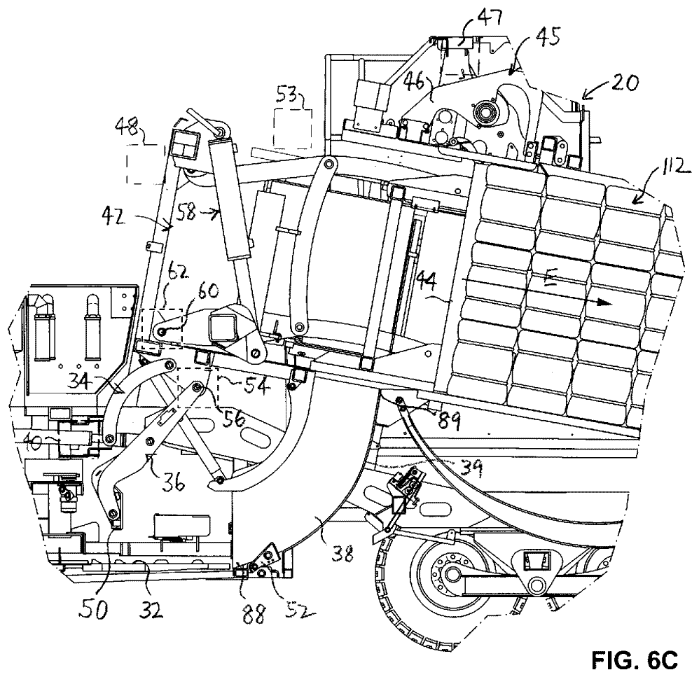

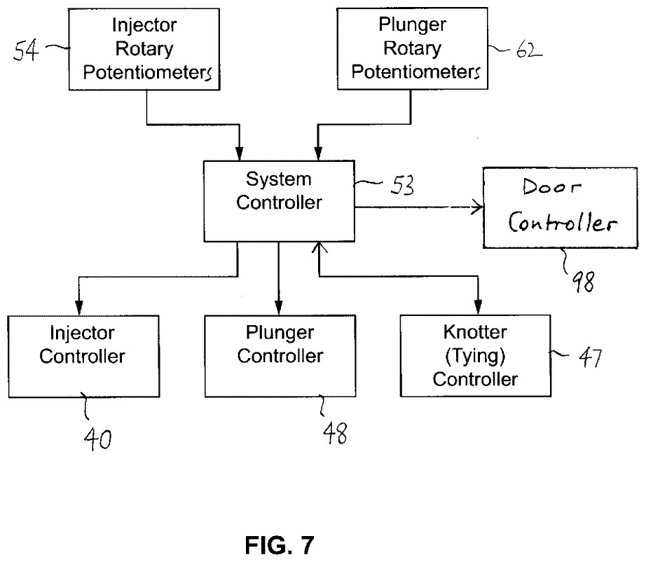

It is also preferred that the system 20 includes an injection assembly 34 positioned in the intake portion 24. Preferably, the injection assembly 34 includes an injector 36 for moving the bales 110 from the table 32 into the loading chamber 26 via a chute 38. The injection assembly 34 preferably also includes an injection controller 40 (FIGS. 6C, 7) for controlling the injector 36 to inject up to the predetermined number of the bales in a column successively into the loading chamber 26 (FIG. 2D).

For instance, where the predetermined number of bales in a column is three (e.g., where the bales are “standard” bales), the injection controller 40 is configured to cause the injector 36 to inject three bales individually in succession into the loading chamber 26, to form the column 114 of three bales 110 therein. As will be described, in one embodiment, the injection assembly 34 preferably positions first and second bales in the column 114 in the chute 38, and then subsequently pushes the third bale through the chute 38 and into the loading chamber to form the column 114, to locate the three bales in the column 114 in the loading chamber 26.

From the foregoing, it can be seen that the injection assembly 34 is configured for moving the predetermined number of bales in a column into the loading chamber 26. As noted above, the predetermined number of bales in a column may vary, depending on the preselected dimensions of the bales. Also, the predetermined number of bales in a column may vary depending on the predetermined dimensions of the bale bundle that is to be formed by the columns.

In summary, the system 20 is for forming the bale bundle 112 that includes the preselected number of columns 114 of bales 110 having preselected dimensions. Each of the columns includes a predetermined number of the bales. The system includes the body assembly 22 with the intake portion 24, the loading chamber 26, and the compression chamber 28 in fluid communication with the loading chamber 26 (FIG. 2B). The loading chamber 26 is formed to receive the predetermined number of the bales in each column respectively.

The compression chamber is partially defined by the floor 64 thereof, and formed to receive the preselected number of the columns of the bales therein.

The system includes the intake assembly 30, which is at least partially positioned in the intake portion 24. The intake assembly includes the table 32 on which each bale is individually positioned at the engagement location, in succession.

The injection assembly 34 preferably at least partially positioned in the intake portion 24. The injection assembly includes the injector 36 and the injector controller 40 for causing the injector to move the predetermined number of the bales individually in succession in the predetermined injection sequence from the engagement location into the chute 38. As noted above, the chute is in fluid communication with the loading chamber. Upon commencing the predetermined injection sequence, the injector controller 40 causes the injector 36 to move a preselected number of the bales in the column into the chute, in which the preselected number of the bales are receivable. The preselected number of the bales is equal to the predetermined number of the bales in the column but one, i.e., the predetermined number minus one.

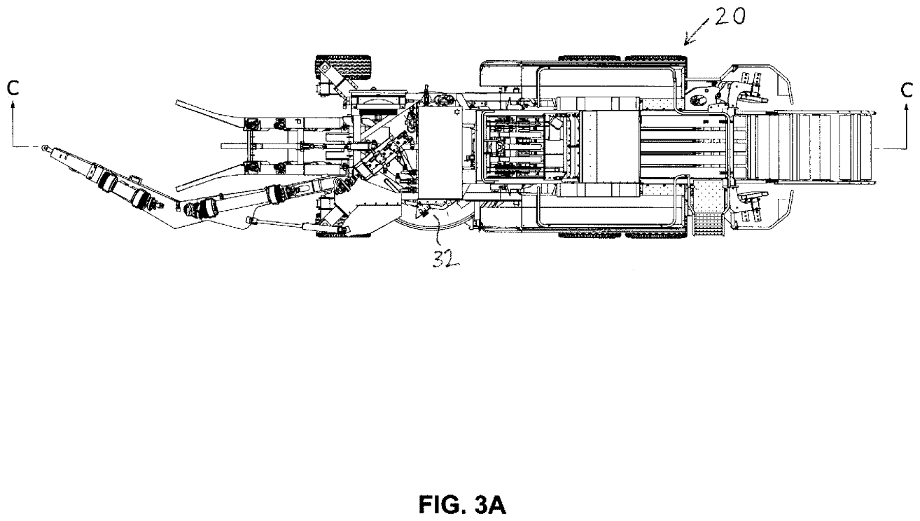

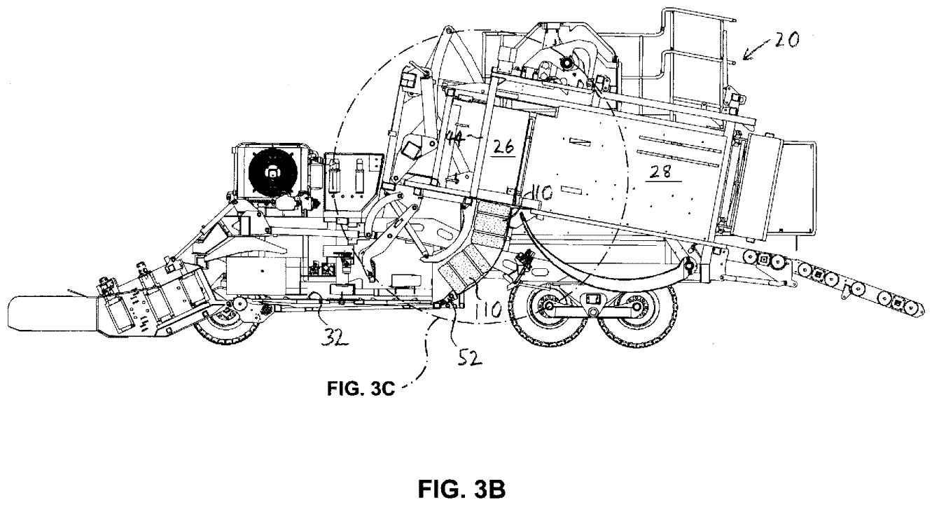

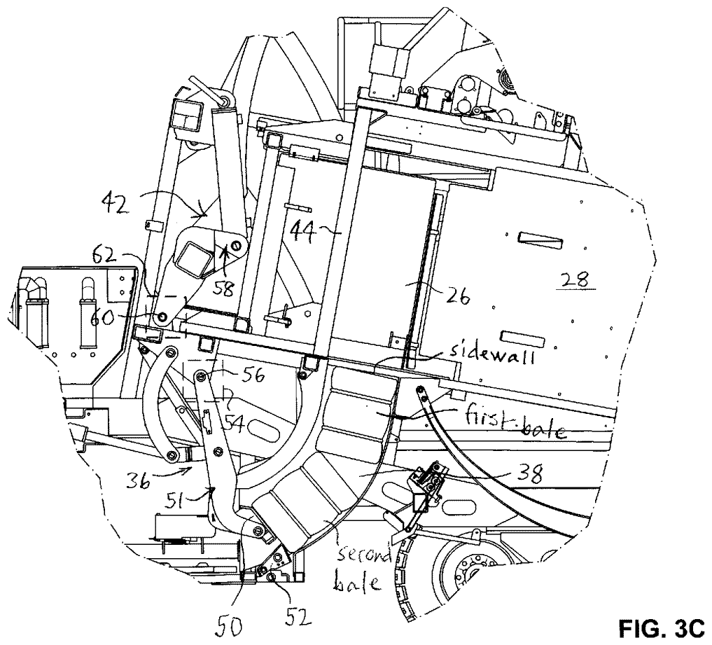

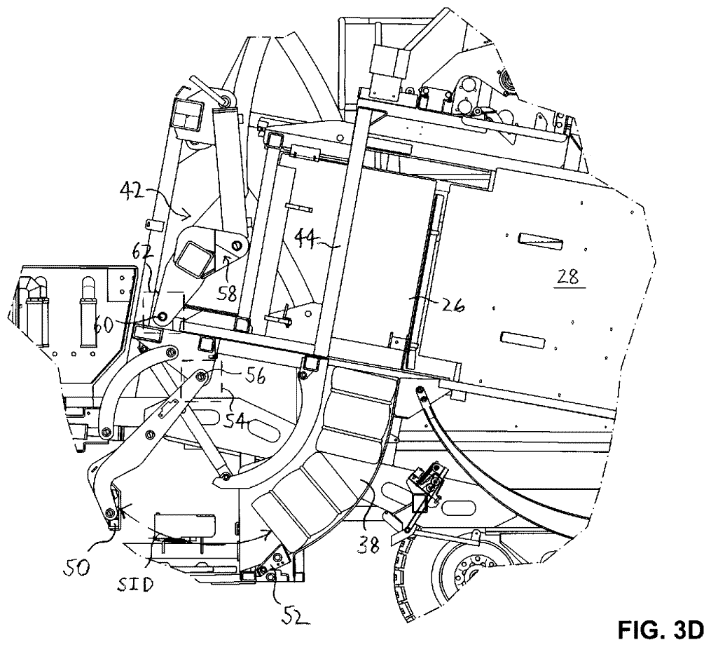

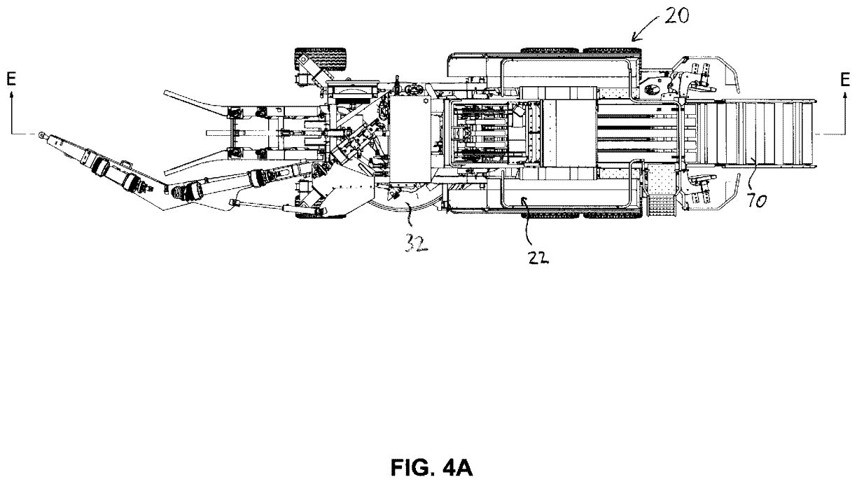

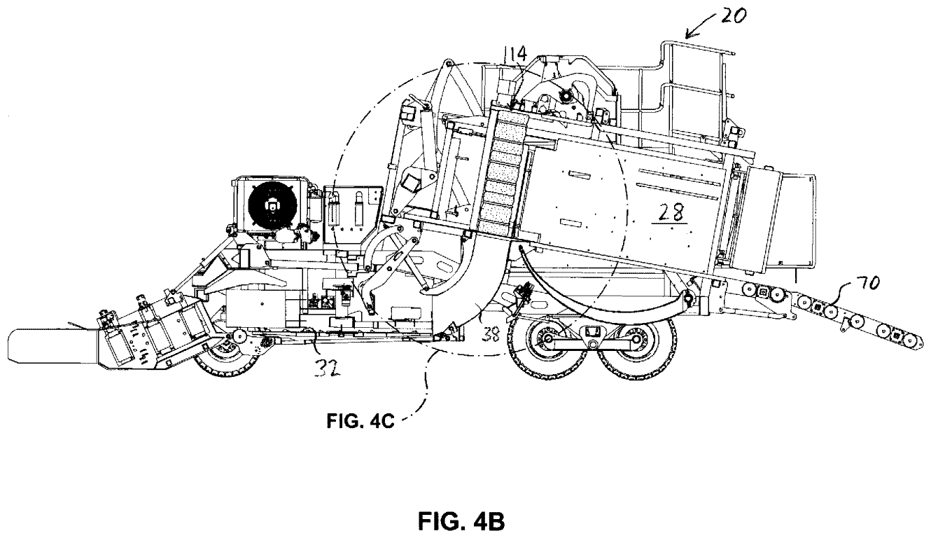

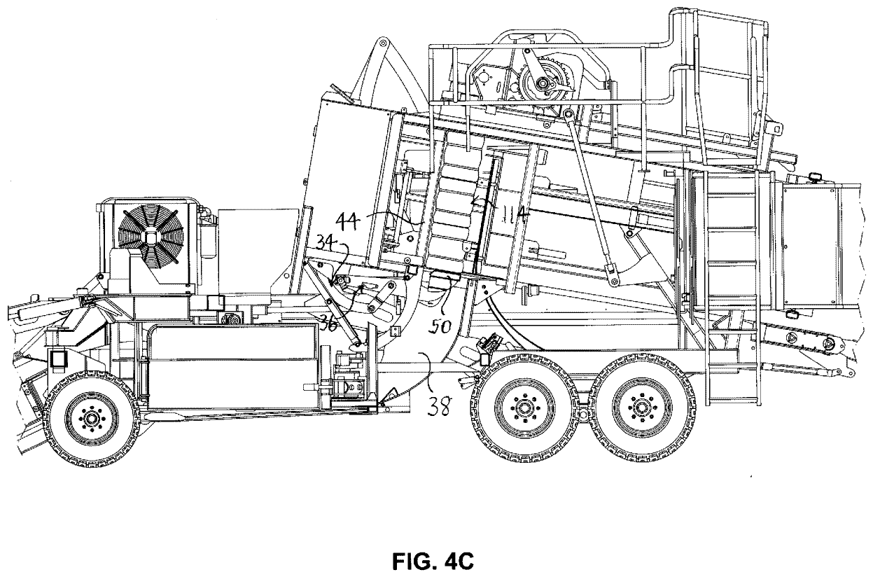

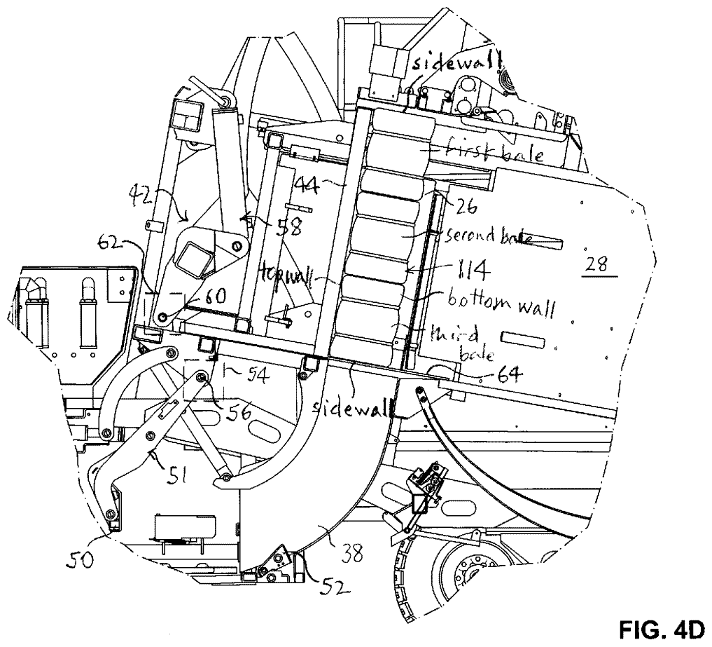

Preferably, the system 20 additionally includes a plunger assembly 42 including a plunger 44 (FIGS. 3C, 4C). The plunger assembly 42 is configured for pushing the preselected number of the columns 114 of the bales individually, in succession from the loading chamber 26 into the compression chamber 28. It is also preferred that the plunger assembly 42 includes a plunger controller 48 (FIGS. 6C, 7), for controlling movement of the plunger 44 relative to the body assembly 22 (FIG. 2B).

The system 20 preferably also includes a knotter assembly (or tying assembly) 45 (FIGS. 2A, 2B), for securing the preselected number of the columns in the compression chamber 28 together to form the bale bundle 112. Preferably, the knotter assembly 45 includes a knotter 46 (FIGS. 2B, 6C) that is controlled by a knotter controller 47 (FIGS. 6C, 7) of the knotter assembly 45.

As will be described, the plunger controller 48 causes the plunger 44 to compress the preselected number of the columns in the compression chamber 28, while the knotter 46 secures the columns together, to form the bale bundle 112.

In summary, upon the preselected number of the columns of the bales being positioned in the compression chamber, the knotter controller 47 activates the knotter 46 to tie the preselected number of the columns of the bales together during the predetermined time period, to form the bale bundle in the compression chamber.

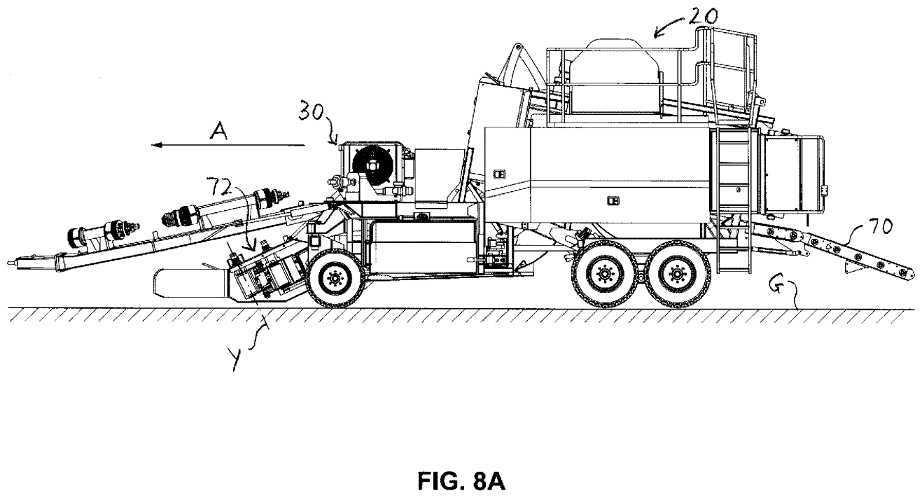

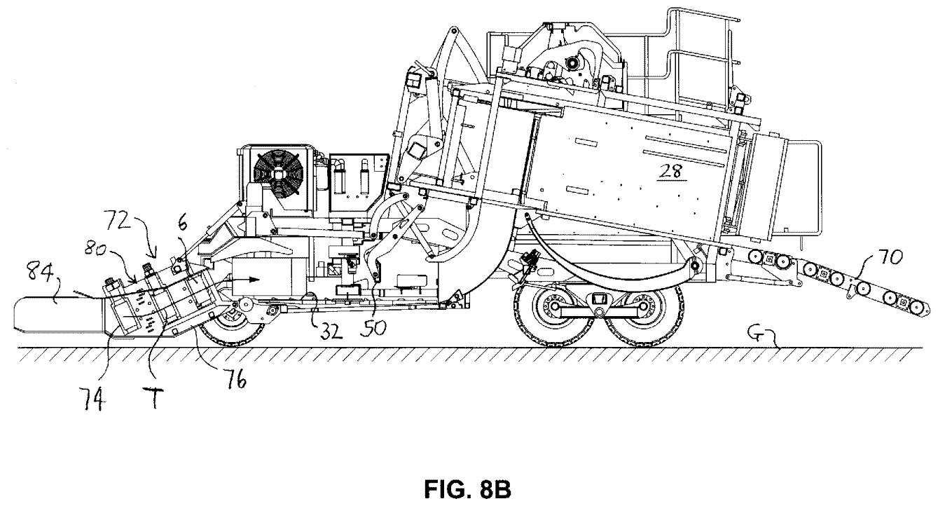

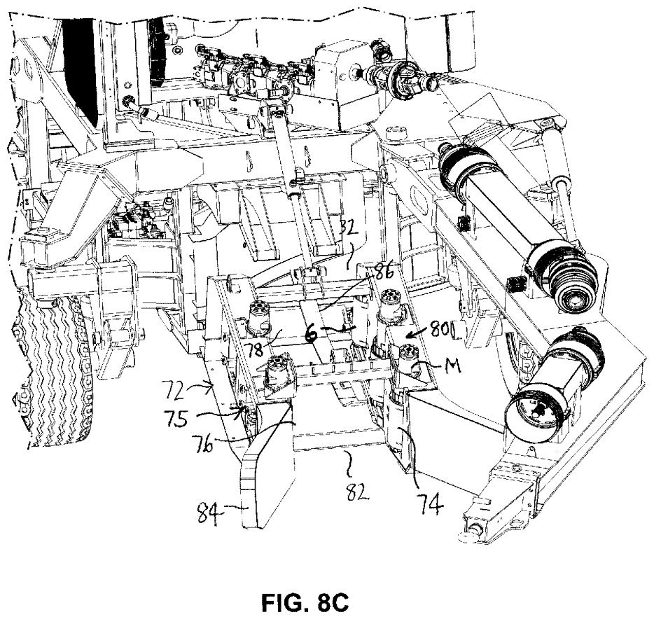

As will also be described, the bales 110 are respectively picked up off the ground, in the field, and moved in the intake portion 24, onto the table 32. It will be understood that the bales 110 preferably are picked up one at a time, as the system 20 is moved in the direction indicated by arrow “A” in FIGS. 1C and 8A. Once the bale 110 is on the table 32, the table 32 rotates about the axis “X” to position the bale 110 in an engagement location on the table 32 (FIG. 1C) relative to the injector 36. In the example illustrated, the direction of rotation of the table 32 is indicated by arrow “B” in FIG. 2A. In one embodiment, the table 32 preferably continues to rotate about the axis “X” while the system 20 is operating.

The injector 36 preferably includes an injector blade 50 that is formed for engaging the bales 110 (FIG. 2C). In FIG. 1C, the injector 36 is shown in its home position. As can be seen in FIG. 1C, when the bale 110 is in the engagement location and the injector 36 is in its home position, the bale 110 is positioned for its engagement by the injector blade 50 (FIG. 1C). It will be understood that the injector blade 50 is omitted from certain drawings for clarity of illustration.

When a column 114 is to be formed in the loading chamber 26 and the bale 110 is in the engagement location, upon receiving an initiation signal from the injection controller 40, the injector 36 preferably pushes the injector blade 50 in the direction indicated by arrow “C” in FIG. 1C. It will be understood that the bale 110 illustrated in FIGS. 1C, 2C, and 2D is the first standard bale in a column that is to be formed. As can be seen in FIG. 2D, the injection assembly 34 also preferably pushes the bale 110 into the chute 38, where the bale 110 is held in a first intermediate position thereof in the chute 38 by one or more dogs 52. The chute 38 is defined by one or more chute walls 39. Although only one dog 52 can be seen in FIGS. 2C and 3C, it will be understood that, as a practical matter, one or more dogs 52 may be mounted to the chute wall 39, to hold the bales 110 in the chute 38 as described.

As can be seen in FIGS. 2B-2D, the chute wall 39 extends between a lower end 88 thereof that is located proximal to the table 32 and an upper end 89 thereof that is proximal to the loading chamber 26.

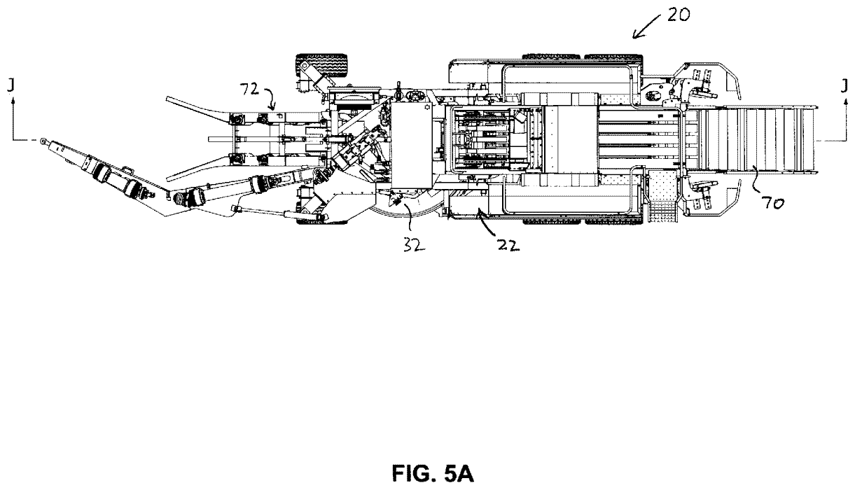

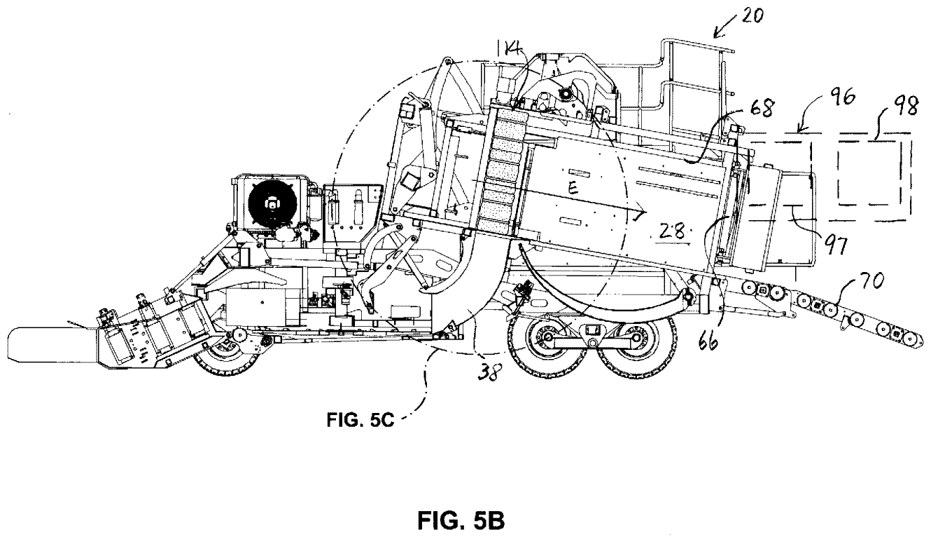

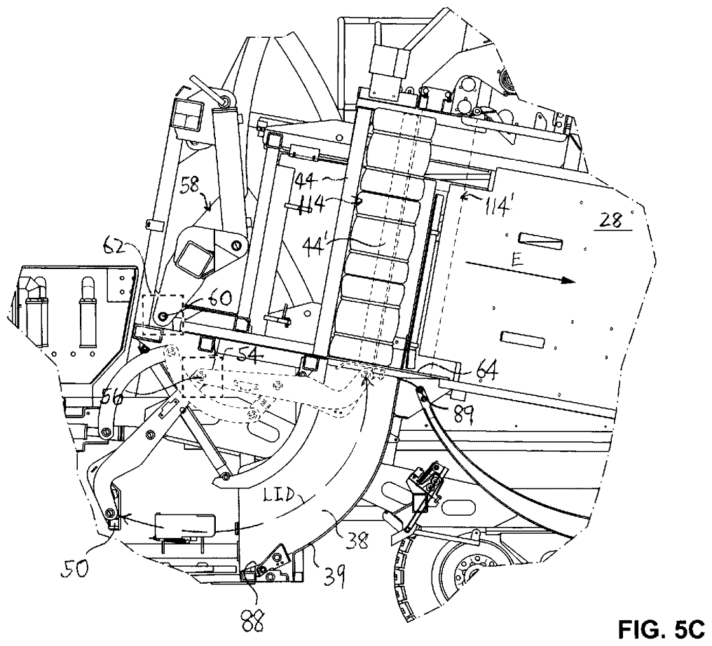

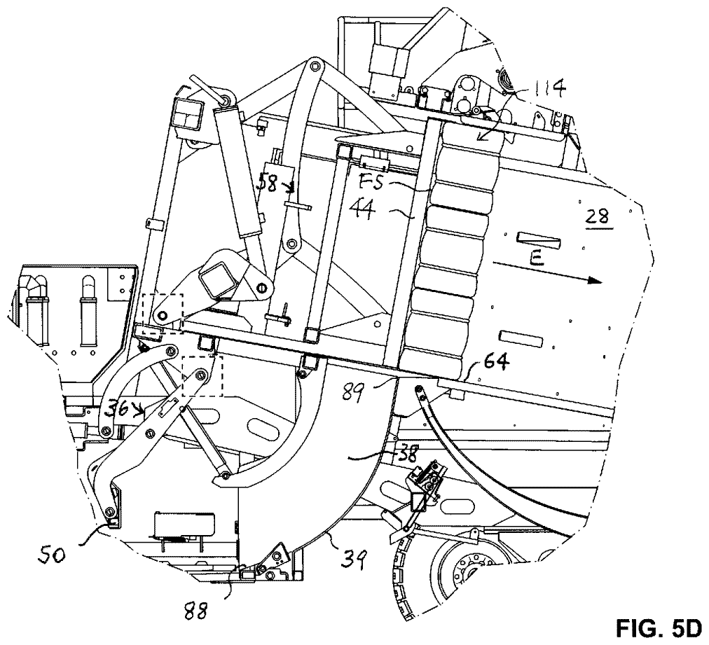

In one embodiment, the one or more dogs 52 preferably are located at the lower end 88 of the chute wall 39 (FIGS. 2B, 5C).

The one or more dogs 52 preferably are positioned at the lower end of the chute wall 39 for supporting the preselected number of bales in the chute 38. The chute 38 preferably is sufficiently large to accommodate the preselected number of the bales therein.

As will be described, the location of the dogs 52 at the lower end 88 of the chute wall is significant, because it enables one or more bales to be positioned in the chute 39 temporarily, before a final bale in the column is pushed into the chute against the bale or bales already present in the chute 38, and all the bales in the column are then pushed by the injector 36 into the loading chamber 26. In short, the location of the dogs 52 at the lower end 88 allows the bale bundles to be formed more quickly in the system 20 of the invention, compared to systems of the prior art.

Preferably, the system 20 includes a system controller 53 (FIGS. 6C, 7), which may be any suitable processor. It will be understood that the injection controller 40 is configured to cause the injector 36 to proceed through a preselected series of steps in a predetermined injection sequence, in order to form the predetermined number of bales in a column, as required for the bale bundle. Once the predetermined injection sequence is completed, it will recommence, unless hatted. Initiation may be manual, or automated, via the system controller 53.

Similarly, the plunger controller 48 is configured to cause the plunger 44 to proceed through a preselected series of steps in a predetermined assembly sequence, in order to form the preselected number of columns into a bale bundle having preselected dimensions. As will be described, the preselected series of steps preferably includes one or more movement steps (in which the columns are moved individually from the loading chamber 26 at least partially into the compression chamber 28), followed by a compression step. Preferably, once the predetermined assembly sequence is completed, it is initiated again by a signal from the system controller 53.

As noted above, depending on the size (i.e., the preselected dimensions) of the bales 110 and the predetermined dimensions of the designed bale bundle 112 that is to be formed, the predetermined number of bales in a column that is to be included in the bale bundle may vary. This means that the number of the preselected series of steps in the predetermined injection sequence may vary accordingly.

For example, where the bales are standard bales, it is preferred that there are three bales in a column. After the first bale is moved into the chute, the process of moving the bale to the engagement location on the table 32 for engagement with the injector blade 50 is repeated for the second and third bales in the column. As another example, where the bales are large bales, the process of positioning the bale on the table 32 for engagement thereof by the injector blade 50 is repeated for only the second bale, i.e., to form a two-bale column.

For clarity of illustration, a portion of the injector 36 is omitted from FIG. 2C. As can be seen in FIGS. 1C and 2C, to locate the first bale 110 in the first intermediate position, the injector blade 50 is moved only a short distance. Preferably, the bale is moved into position in front of the blade 50 after the injector 36 is in its home position. As will be described, this is only a first step in the predetermined injection sequence to which the injector 36 is subjected.

It will be understood that the predetermined injection sequence for each bale size varies, according to the predetermined number of bales in a column that is to be included in a bale bundle formed with the columns of the bales.

As noted above, as an example, standard bales are illustrated in FIGS. 3A-3D. Referring to FIGS. 3A-3D, a second standard bale 110 preferably is pushed by the injector 36 into the chute 38 against the first bale, so that the second bale is then located in the chute 38 in the first intermediate position. As a result, at that point, the first bale is pushed by the second bale into a second intermediate position. Both of the first and second standard bales are held in the chute 38 by the dog 52 (FIGS. 3B, 3C).

It will be understood that the strokes of the injector assembly 34 used to move the first standard bale and the second standard bale into the chute 38 are the same for both of the first and second bales, i.e., each of the first and second strokes is relatively short. The short first and second strokes have the advantage that they can be executed relatively quickly. As will be described, where the bales are standard bales, a third bale is required to complete the column, and the third injector stroke preferably is relatively long.

In one embodiment, the length of the stroke of the injector 36 preferably varies, depending on the step of the relevant predetermined injection sequence in which the stroke takes place. For example, if the bales are standard, then the injector controller 40 causes the first and second bales to be pushed into the chute 38 with two equal short strokes respectively (FIGS. 3C, 3D). Next, the third standard bale is pushed by the injector 36 off the rotating table 32, and into the chute 38. It will be understood that the third bale is moved by the injector 36 in a third preselected step of the predetermined injection sequence for standard bales.

Preferably, the third step in the predetermined injection sequence for the standard bales is a relatively long stroke, in which the third bale is first pushed against the second bale. As a result, the second bale is pushed, in turn, against the first bale. Subsequently, while the third bale is engaged with the second bale and the second bale engages the first bale, the three bales are pushed up the chute 38 and then into the loading chamber 26 (FIGS. 4C, 4D).

It will be understood that the predetermined injection sequence (i.e., the number and lengths of strokes of the injector 36) may be varied depending on the preselected dimensions of the bale, and the predetermined dimensions of the bale bundle. As noted above, for example, if large bales are utilized, then the injector pushes only the first large bale into the chute 38 in a short first stroke, and the injector subsequently pushes both the second large bale and the first large bale through the chute 38 and into the loading chamber 26, in a relatively long second stroke.

As noted above, in the example illustrated in the drawings, each of the columns 114 preferably includes three standard bales. The manner in which the third standard bale is moved (with the first and second standard bales) by the injector 36 through the chute 38 and into the loading chamber 26 in a single, long stroke can be seen in FIGS. 4C and 4D. It will be understood that, similarly, where the bales are large, the second bale is pushed into the chute to engage the first bale, and then the first and second large bales (not shown) preferably are both moved through the chute 38 and into the loading chamber 26 at the same time, by a single, long stroke of the injector 36.

As can be seen in FIG. 3C, when the first two standard bales of a column are positioned in the chute 38, the bales are located well below the loading chamber 26. The location of the first two standard bales in the chute 38 and below the loading chamber 26 is advantageous, for the following reasons: First, while a bale bundle is simultaneously being compressed and tied in the compression chamber 28, the first two standard bales of the first column of the next bale bundle can be moved into the chute 38 without interfering with or affecting the operation of the plunger assembly 42 or the tying assembly 45. This is possible because the chute 38 is sufficiently large to receive the first and second bales without those bales encroaching into the loading chamber 26.

Second, because the first and second bales are moved into the chute 38 by two relatively short strokes of the injector 36, the first two bales are moved into position in the chute 38 relatively quickly.

In summary, because an initial bale or an initial two bales in a column are receivable in the relatively large chute 38, significantly less time is required for completion of the predetermined injection sequence than in a corresponding sequence in a conventional bale stacker.

Less time is required (in comparison to the prior art) because of the relatively short strokes used to move the preselected number of the bales into the chute. Preferably, in the predetermined injection sequence, the injector 36 moves each of the preselected number of the bales into the chute over a short injection distance. As an example, the short injection distance is schematically represented in FIG. 3D as distance “SID”.

The short injection distance is the distance the injector blade 50 of the injector 36 travels when the injector moves from the home position thereof (FIG. 1C), in which the injector blade 50 is located for engagement with the bale positioned at the engagement location, to a delivery position thereof (FIGS. 2C, 3C), in which the injector blade positions the preselected number of the bales in the chute 38.

As can be seen in FIGS. 3C, 3D, 4C and 5C, after the preselected number of the bales in the column is located in the chute, the injector controller causes the injector to move a final bale to be included in the column in the predetermined injection sequence from the engagement location to engage with the preselected number of the bales in the chute, and then to push the predetermined number of the bales in the column into the loading chamber, in a long stroke of the injector 36, to form the column of the bales in the loading chamber.

In the long stroke, the injector blade 50 is moved a relatively long distance identified as “LID”. The long injector distance “LID” is schematically illustrated in FIG. 5C. Preferably, in the long stroke of the injector 36, the injector 36 moves from the home position thereof, in which the injector blade 50 is located for engagement with the bale positioned at the engagement location, to the delivery position thereof, in which the injector blade supports the predetermined number of bales in the column in the loading chamber.

Those skilled in the art would appreciate that, as can be seen in FIGS. 4C and 4D, the injector 36 utilizes a long stroke in order to move all three standard bales (first, second, and third) into the loading chamber 26. As shown in FIG. 4D, it is also preferred that the injector blade 50 remains engaged with the third bale for a short time period after the three bales are located in the loading chamber 26, so that the injector 36 is supporting all three standard bales in the loading chamber 26 during such short time period, when the bales are first formed into the column 114 in the loading chamber 26.

Preferably, the injector assembly 34 includes an injector support subassembly 51 that includes elements connected to each other at pivot points, enabling the injector 36 to move between the home position thereof (FIG. 1C) and an extended position thereof that is illustrated in FIG. 4D. Those skilled in the art would appreciate that the injector blade 50 may be moved by any suitable means. For instance, in one embodiment, it is preferred that the injector 36 includes one or more hydraulic cylinders (not shown) that, indirectly connected with the injector blade 50 via the injector support subassembly 51 or otherwise, cause the injector blade 50 to be moved in accordance with instructions provided by the injection controller 40. The instructions preferably are for the preselected series of steps of the predetermined injection sequence.

Those skilled in the art would appreciate that the injector assembly 34 may be controlled using any suitable means and methods. In one embodiment, the injector controller 40 determines the next step to be taken in the predetermined injection sequence, based on data received by the injector controller 40 from one or more injector rotational potentiometers 54 (FIG. 3C). (It will be understood that instructions to initiate the predetermined injection sequence may be provided to the injection controller 40 by the system controller 53). The injector rotational potentiometers 54 provide data that enables the injector controller 40 to determine which of the preselected steps in the predetermined injection sequence have been completed. Preferably, the one or more injector rotational potentiometers 54 are located at one or more suitable pivot points 56 in the injector support subassembly 51 (FIG. 3C). It will be understood that the injector rotational potentiometers 54 are only schematically represented in FIGS. 2D, 3D, 4D, 50, 6C, and 7. Data from the injector rotational potentiometers 54 preferably is also transmitted to the system controller 53, which generates signals to the injector controller 40 and the plunger controller 48 based on such data, and based on the predetermined injection sequence.

The injector controller 40, the plunger controller 48, the knotter controller 47, and the system controller 53 may each be, for example, a programmable logic controller (“PLC”), or any other suitable data processor. It will be understood that each of the controllers preferably is configured so that an operator may relatively easily change parameters, e.g., so that the length of a stroke of the injector 36 may be adjusted if necessary. Also, adjustments to the predetermined injection sequence and the predetermined assembly sequence necessary to accommodate changes in the bales (e.g., a change from standard bales to large bales, and vice versa) may be relatively easily made at the relevant controllers.

In one embodiment, in accordance with signals transmitted from the system controller 53 to the injector controller 40, the injector controller 40 preferably causes the injector 36 to start the predetermined injection sequence for each column respectively. Each step in such sequence preferably commences once the injector 36 is returned to its home position. As will be described, the predetermined injection sequence preferably commences shortly after a column of bales is moved, at least partially, from the loading chamber 26 into the compression chamber 28 by the plunger 44, so that the column is supported above the chute 38 by the floor 64.

When the injector blade 50 returns in its home position, a bale preferably is moved to the engagement location on the table. Such movement is due to rotation of the table. It will be understood that, after a column including the predetermined number of the bales has been formed by the injector assembly 34 in the loading chamber 26, the first bale that is in the engagement location on the table is to be the first bale in the next column to be formed in the loading chamber 26.

Preferably, the system controller 53 is programmed so that the signals from the injector rotational parameters 54 are recognized as indicating where the injector blade 50 is at any point in the cycle (i.e., in a step in the preselected series of steps) between the home position of the injector 36 (FIGS. 1C, 4D) and the extended position (FIG. 4C) thereof. Accordingly, when the injector 36 is in its extended position, due to the rotation of a part of the injector support subassembly 51, the one or more injector rotational potentiometers 54 provide data to the system controller 53. After the first column is in the loading chamber, such data indicates that the predetermined assembly sequence is to commence. The system controller 53 processes such data accordingly, and then transmits an appropriate signal to the plunger controller 48, to initiate the predetermined assembly sequence.

As a result, once the injector 36 is in its extended position (FIG. 4C) for the first column of the bales to be included in a new bale bundle, the system controller 53 transmits a suitable signal to the plunger controller 48, initiating the predetermined assembly sequence. Due to such signal, the plunger controller 48 causes the plunger 44 to move in the direction indicated by arrow “E” (FIG. 5C). It will be understood that the plunger 44 is supported and moved by a plunger support subassembly 58.

The plunger support subassembly 58 preferably includes a number of elements, connected to each other at respective pivot points 60. In one embodiment, the plunger 44 is moved by one or more hydraulic cylinders that are pivotably connected to the plunger 44. Preferably, the system also includes a number of plunger rotational potentiometers 62 that are mounted at the pivot points 60 in the plunger support subassembly 58. The plunger 44 is movable between its home position (FIGS. 20, 3C, 4C) and its extended position (FIG. 6C) by a hydraulic cylinder, supported by the plunger support subassembly 58. It will be understood that the plunger rotational potentiometers 62 are only schematically represented in FIGS. 2D, 3C, 3D, 4D, 50, 6C, and 7.

The system controller 53 controls the plunger 44 via the plunger controller 48, based on data from the injector rotational potentiometers 54 and from the plunger rotational potentiometers 62, and also based on signals from the knotter controller 47. Data transmitted from the plunger rotational potentiometers 62 and also from the injector rotational potentiometers 54 (preferably, at short intervals) to the system controller 53 enables the system controller 53 to determine suitable instructions to the plunger controller 48 for movement of the plunger 44, and to the injector controller 40 for movement of the injector 36, and also suitable instructions to the knotter controller 47, as will be described.

As noted above, in the movement steps of the predetermined assembly sequence, the plunger 44 pushes the column that is in the loading chamber 26 at least partially into the compression chamber 28 (i.e., onto the floor 64), until the floor 64 sustains the column above the chute 38.

The location at which the floor 64 sustains the column above the chute may be determined by trial and error. Once the location is determined, it may be input into the plunger controller 48.

It will be understood that the plunger controller 48 is configured to determine, based on data from the plunger rotational potentiometers 62, when the column is located on the floor 64 in the predetermined location at which the floor 64 sustains the column above the chute 38. Once the plunger controller 48 has determined that the column is in a position where it should be sustained by the floor 64, the plunger controller 48 transmits an appropriate signal to so indicate to the system controller 53. At that point, the system controller 53 transmits a signal to the injector controller 40 indicating that the predetermined injection sequence has ended, for the column of the bales recently moved into the loading chamber. As a result, the injector controller 40 causes the injector 36 to return to its home position, to commence the next predetermined injection sequence. Accordingly, the blade 50 is disengaged from the column and is positioned to move the next bale that is located on the table, in the engagement location.

From the foregoing, it can be seen that the injector controller 40 is configured to count the steps of the preselected series of steps that have been taken, in the predetermined injection sequence. This is done based on data from the injector rotational potentiometers 54. For the purposes hereof, the predetermined number of bales moved in the predetermined injection sequence (i.e., the predetermined number of bales in a column) is referred to as “N”. For example, where the bales are standard bales, “N” is equal to three.

It can also be seen that the steps in the predetermined injection sequence for the predetermined number of bales but one (“N−1” bales) differ from the step of moving the final bale in the column to be formed. For the purposes hereof, the “N−1” number of the bales (i.e., the predetermined number of bales in a column, minus one) is referred to as the “preselected” number of the bales. For example, where the bales are standard bales, the preselected number “N−1” of bales is two. In these circumstances, it will be understood that the injector's stroke for each of the first two bales in the column is the same short stroke, i.e., over the same distance. The stroke required for the final (third) bale is a long stroke.

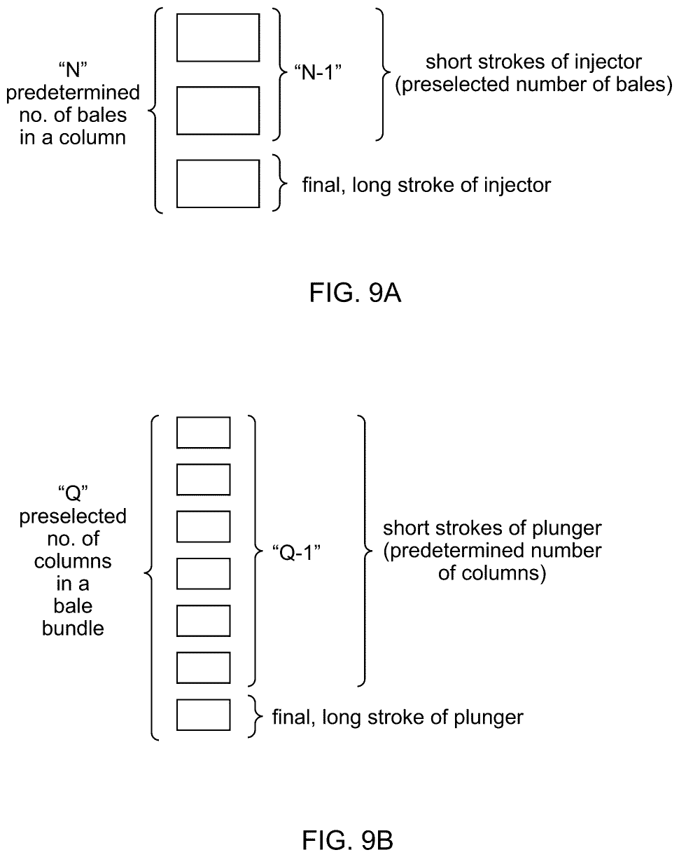

The general relationship between the short strokes and the final, longer stroke in the predetermined injection sequence, where the bales are standard bales, is schematically illustrated in FIG. 9A.

It will be understood that the series of preselected steps in the predetermined injection sequence depends on the preselected dimensions of the bales. For example, if the bales are standard bales, then the series of preselected steps in the sequence is: a first short stroke, a second short stroke, and a third long stroke (FIG. 9A). If the bales are large bales, then the series of preselected steps in the sequence is: a first short stroke, and a second long stroke (FIG. 9A).

Accordingly, where the bales are large bales, “N” (i.e., the predetermined number of bales in a column) is two. The preselected number of bales (i.e., “N−1”), is one. The first bale in the column is moved into the chute 38 with a short stroke of the injector 36. The stroke to move the final large bale (and the first large bale) into the loading chamber 26 is a long stroke.

### Standard Bales Example—Plunger

It will also be understood that the plunger controller 48 causes the plunger 44 to proceed through the predetermined assembly sequence for each bale bundle. The predetermined assembly sequence commences upon the plunger controller 48 receiving a signal from the system controller 53 indicating that a first column 114 to be included in a new bale bundle is in the loading chamber 26 (FIGS. 4D, 5C). This signal is generated upon the injection controller 40 receiving data from the injector rotational potentiometers 54 indicating that the predetermined injection sequence for a column has been completed, i.e., the injector has completed its long stroke. The injector controller 40 then sends a suitable signal to the system controller 53.

At this point, the injector blade 50 remains engaged with the final bale in the column. The injector 36 temporarily supports the column in the loading chamber, until the plunger moves the column to a predetermined location on the floor 64 at which the floor supports the column above the chute 38.

As noted above, while the column is supported by the injector 36, the plunger 44 moves the first column at least partially into the compression chamber 28, to the predetermined location, at which the column is supported by the floor 64 above the chute 38. This movement of the first column is the first of the movement steps of the predetermined assembly sequence of the plunger assembly 42.

The number of movement steps in the predetermined assembly sequence depends on the predetermined dimensions of the bale bundle, which in turn depend on the preselected dimensions of the bales. As described above, where the bales are “standard”, the bale bundle may include seven columns of such bales. In that case, the preselected series of steps of the predetermined assembly sequence preferably includes: (i) six consecutive movement steps, in which the first six columns are each pushed into the compression chamber 28 until the floor 64 sustains each respective column above the chute 38, and (ii) a seventh compression step, in which the seventh column is pushed against the preceding six columns by the plunger 44, and then all seven columns are compressed for a predetermined time period between the plunger 44 and a rear door 66 (FIGS. 5B, 9B). The predetermined time period is a time period sufficient to allow the knotter 46 to tie the seven columns of bales together to form the bale bundle.

Accordingly, in the first step, the plunger 44 moves the first bale a preselected distance, to the predetermined location at least partially in the compression chamber, where the column is supported above the chute 38 by the floor 64. This is repeated for the first six columns of the new bale bundle of standard bales. Preferably, each of the strokes of the plunger 44 for each of the first six columns is over the same, relatively short distance. It will be understood that each such stroke is a movement step. After the first column in a new bale bundle is pushed into the compression chamber 28, the five subsequent columns each push the immediate preceding column thereto (i.e., which column is already at least partially in the compression chamber 28) toward the rear door 66.

When the seventh column of standard bales is loaded into the loading chamber 26, the plunger controller 48 preferably causes the plunger 44 to move a longer distance, to compress the seven columns in the bale bundle. In this compression step, the plunger 44 preferably compresses the columns for the predetermined time period, to allow the knotter 46 to tie the columns in the new bale bundle together, to form the new bale bundle.

In summary, the system 20 preferably includes the plunger assembly 42 which includes the plunger 44 and the plunger controller 48. The plunger controller is configured to cause the plunger 44 to move the preselected number of the columns of the bales individually in succession from the loading chamber into the compression chamber, in the predetermined assembly sequence. In the predetermined assembly sequence, the plunger moves a predetermined number of the columns of the bales into the compression chamber with respective short strokes of the plunger. The predetermined number of the columns is the preselected number of the columns, but one. Also, the plunger moves the final column of the bales in the predetermined assembly sequence against the predetermined number of the bales that is in the compression chamber, to provide a total of the preselected number of columns in the compression chamber 28. Upon the preselected number of the columns of the bales being located in the compression chamber, the plunger controller causes the plunger to compress the preselected number of the columns of the bales between the plunger and a rear door of the body assembly with a long stroke thereof for a predetermined time period.

In one embodiment, when the bale 110 is in the engagement location on the table 32, one of its sidewalls preferably faces the injector blade 50 (FIG. 1C). Because of this, and as can be seen in FIGS. 1C, 2D, 3C, and 4D, when the standard bales are located in the column 114 in the loading chamber 26, each of the bales in the column rests on a sidewall thereof, and a top or a bottom side of each of the bales faces the plunger 44 (FIG. 4D). Accordingly, when the plunger 44 compresses the bales (i.e., by pushing in the direction indicated by arrow “E”), the plunger 44 is pressing against top or bottom sides of the bales, and the opposite sides of the bales in the first column of the bale bundle are pressed against the rear door 66.

As can be seen, for example, in FIG. 4D, the top walls of the bales in the column in the loading chamber 26 are facing the plunger 44. This is the preferred orientation of the bales in the columns. Those skilled in the art would appreciate that, in order to achieve the preferred orientation in the column, each of the bales preferably is located in the engagement location in a predetermined orientation (FIG. 1C), in which the bale rests on its bottom wall on the table 32 and the top wall is facing upward, and one of the sidewalls of the bale is positioned for engagement by the injector blade 50. As will be described, the system preferably includes an assembly for picking up the bales off the ground and positioning them in the predetermined orientation in the engagement location on the table 32.

Those skilled in the art would appreciate that the bales may be positioned in any suitable orientation in the columns, and in the bale bundle. The orientation of the bales in the columns and in the bale bundle as described herein and as illustrated in the attached drawings is only one possible orientation. In the embodiment illustrated in FIGS. 1C and 2A-6C, it is preferred that the bales are oriented in the columns with the short sides thereof positioned horizontally (or substantially horizontally), i.e., parallel to the floor 64 of the compression chamber, and the longer sides thereof positioned vertically (or substantially vertically), i.e., orthogonal to the floor 64. It is believed that this preferred orientation provides a bale bundle with a generally consistent density throughout. Also, the bale bundle that includes bales in this preferred orientation is generally stable, and tends to remain together and cohesive during lifting and handling.

Preferably, the plunger 44 pushes the column 114 in the direction indicated by arrow “E”, once the system controller 53 has determined that the column 114 is located in the loading chamber 26 and signalled to the plunger controller 48 accordingly. As noted above, when the column 114 is first moved to the loading chamber 26, the column 114 is supported by the injector blade 50 (FIGS. 4C, 5C, 6C). Those skilled in the art would appreciate that the loading chamber 26 is open at its bottom end, and in the situation shown in FIG. 4C, in the absence of the injector blade 50 engaging the column at its lower end, the column would not be supported in the loading chamber 26, above the chute 38.

While the injector 36 supports the column 114 in the loading chamber 26, the plunger 44 preferably pushes the column toward the rear door 66 until the column is at the predetermined location at which the column is supported above the chute by the floor 64. It has been found that, once about one half of the column is supported by the floor 64, the floor 64 supports the column above the chute.

Those skilled in the art would also appreciate that, due to the injector rotational potentiometers 54, data about the position of the injector blade 50 (i.e., as shown in FIG. 4C) is transmitted to the injector controller 40, and also to the system controller 53. Preferably, once the system controller 53 is informed that a complete column 114 is located in the loading chamber 26 (i.e., the predetermined injection sequence has been completed), the system controller 53 transmits an actuation signal to the plunger controller 48, to cause the plunger 44 to be moved in one or its steps in the predetermined assembly sequence. The plunger controller 48 is configured to count the steps in the preselected series of steps (i.e., several movement steps, followed by a compression step) in the predetermined assembly sequence. Accordingly, the plunger 44 is caused by the plunger controller 48 to be moved according to whether such movement is to effect one of the movement steps, or the compression step. As described above, the number of steps that is in the preselected series of steps depends on the predetermined dimensions of the bale bundle.

Once the column has been moved by the plunger 44 to the location where the floor 64 supports the column above the chute 38, the injector blade 50 is retracted from its extended position (FIG. 4D) to its home position (FIG. 1C). As noted above, when the injector blade 50 is in its home position, then the injector blade 50 is ready to engage with the bale that is positioned in the engagement location on the table 32, e.g., as illustrated in FIG. 1C. The injector controller 40 is configured to count the steps in the preselected series of steps in the predetermined injection sequence. The number of steps in the preselected series of steps in the predetermined injection sequence depends on the preselected dimensions of the bale.

Those skilled in the art would appreciate that the predetermined injection sequence outlined above has the advantage that, as the injector 50 is retracting from its extended position (FIG. 4C) to its home position, the plunger 44 is moving the column 114 at least partially into the compression chamber 28, to the point at which the floor 64 supports the column above the chute 38.

As can be seen in FIG. 5C, the compression chamber 28 preferably is partially defined by the floor 64. When the system 20 is positioned on level ground, the floor 64 preferably is located at an angle of about 10° relative to the horizontal. Locating the floor 64 in this way is believed to be advantageous because it encourages the bale bundle 12 to exit the compression chamber 28 due to gravity, once the bale bundle 12 has been formed. Also, due to the position of the floor 64 relative to the horizontal, it is believed that the floor 64 may support the column above the chute 38 in the engagement location when approximately half, or less than half, of the column is positioned in the compression chamber 28, depending largely on the position of the body assembly 22 at the time, relative to the horizontal. The positions of the plunger and the column when the column is in the engagement location, i.e., supported above the chute 38 by the floor 64, are shown in FIG. 5C, in dashed outlines.

For clarity of illustration, the column that is in the engagement location is outlined in dashed lines and identified by reference character 114′ in FIG. 5C. Also, the plunger a position to locate the column 114″ in the engagement location is identified in FIG. 5C by reference character 44′.

As noted above, once the column has been moved by the plunger 44 sufficiently far in the direction indicated by arrow “E” that the column is supported above the chute 38 by the floor 64, the injector assembly 34 retracts the injector blade 50 from its extended position to the home position thereof. Those skilled in the art would appreciate that the system controller 53 preferably is configured to cause the injector controller 40 to retract the injector 36 when the plunger rotational potentiometers 62 indicate that the plunger 44 is at a predetermined location relative to the floor 64, at which position the floor 64 can support the column above the chute 38.

It will be understood that, in FIG. 5B, the injector blade 50 is omitted for clarity of illustration. From the foregoing, however, it can be seen that the injector blade 50 remains in its extended position (i.e., as shown in FIG. 4C) until the plunger 44 has moved the column to the predetermined location on the floor 64 at which the floor 64 sustains the column above the chute 38, e.g., as illustrated in dashed outline in FIG. 5C.

As the plunger 44 moves from its home position (FIG. 4D) to the position in which the plunger 44 locates the column at the predetermined location, where the floor 64 sustains the column above the chute 38 (outlined in dashed outline in FIG. 5C), the elements in the plunger support subassembly 58 also move relative to each other. Such movement is tracked by the plunger rotational potentiometers 62, and the information is transmitted to the plunger controller 48. Once the plunger is in the predetermined position in which it is identified by reference character 44′ in FIG. 5C (i.e., the position at which the floor 64 sustains the column above the chute 38), the plunger controller 48 transmits a signal to the system controller 53 accordingly which transmits a suitable signal to the injector controller 40. Such signal causes the injector controller 40 to move the injector blade 50 from its extended position to its home position.

Also, upon its receipt of the data from the plunger rotational potentiometers 62, the plunger controller 48 causes the plunger 44 to be retracted, to enable the next column of the bales to be injected into the loading chamber 26.

In summary, once the column is positioned as illustrated in FIG. 5C (i.e., when the column is supported by the floor 64 above the chute), the injector blade 50 preferably is removed, and the injector returns to its home position (FIGS. 1C, 5C). However, it will be understood that, at that point, the plunger 44 preferably continues to push the column that had been in the loading chamber in the direction indicated by arrow “E”, until the column has cleared the chute (FIG. 5D), i.e., to an unobstructive location. When the column is in the unobstructive location, the loading chamber is unobstructed by the column, to permit the next column of bales to be pushed into the loading chamber 26.

As can be seen in FIG. 5D, when the column 114 is in the unobstructive location thereof, a first side “FS” thereof is generally aligned with the top end 89 of the chute wall 39.

While the plunger 44 moves the column of bales that had been in the loading chamber from the predetermined location of the plunger (FIG. 5C) to the unobstructive location (FIG. 5D), the injector preferably commences the predetermined injection cycle, pushing the first and second bales of the next column into the chute 38. After the plunger 44 has pushed the previous column to the unobstructive location, the plunger 44 preferably returns to its home position, at which the plunger 44 is positioned for engagement with the next column that is positioned in the loading chamber, in the next step of the predetermined assembly sequence.

As noted above, where the bales are standard, each of the movement steps of the plunger 44 in the predetermined assembly sequence for each of the first six columns in a bale bundle preferably is the same, relatively short stroke. Preferably, the plunger controller 48 is configured to cause the plunger 44 to be moved a short predetermined distance for each of the plunger's first six strokes in the preselected series of steps in the predetermined assembly sequence. Each of the first six strokes in the series is a short predetermined distance that is sufficient to enable the plunger to locate the column of bales in the unobstructive location.

Preferably, in each of the movement steps, the movement of the plunger 44 from its home position to the unobstructive location is an unbroken movement. For example, where the bales are standard bales, during the movement steps, the plunger 44 moves from its home position to the unobstructive location and returns to its home position six times in succession. As noted above, in each movement step, when the plunger 44 has located the column in the predetermined location, the injector returns to its home position and commences another predetermined injection sequence.

In practice, this means that after the first column is pushed into the compression chamber 28, each of the first six columns pushes the column(s) that preceded it into the compression chamber 28. However, the plunger controller 48 is also configured to push the final (i.e., the seventh) column into the compression chamber 28 in the compression step, with a stroke that is longer than each of the previous six strokes, to compress the columns. When the plunger 44 is positioned at the end of the seventh stroke, the plunger 44 is at its extended position.

Preferably, the plunger controller 48 is also configured to cause the plunger 44 to remain in its extended position for a predetermined period of time. While the plunger 44 is in its extended position, the columns are compressed between the plunger 44 and the rear door 66, and also between the floor 64 and a ceiling 68 of the compression chamber 28 (FIGS. 5B, 5C). The predetermined period of time during which the plunger 44 is in its extended position preferably is sufficient to allow the tying assembly 45 to complete tying the columns together during that time and while they are compressed by the plunger, to form the bale bundle 112.

It will be understood that, regardless of bale size, once the system controller 53 receives a signal indicating that the plunger 44 is fully extended, the system controller 53 is configured to transmit an activation signal to the knotter controller 47, to cause the knotter 46 to activate. The activation signal is generated when data from the plunger rotational potentiometers 62 that indicates that the plunger 44 is held in its extended position is transmitted to the plunger controller 48, which then transmits an appropriate signal to system controller 53. Once activated, the knotter 46 ties a suitable material (e.g., a nylon string) around the bale columns, to hold them together in the bale bundle.

As noted above, the plunger 44 remains fully extended, compressing the predetermined number of the columns together, while the knotter 46 ties the columns together for form the bale bundle.

When the knotter 46 has tied the columns of bales together, the knotter controller 47 transmits a suitable signal to the system controller 53 accordingly. The system controller 53 in turn transmits a signal to the plunger controller 48, to cause the plunger controller 48 to restart the predetermined assembly sequence.

Preferably, when the plunger 44 commences the compression step, the injector commences the next predetermined injection sequence. Accordingly, while the plunger 44 is extended in its compression step, the first two bales of the next column are positioned in the chute 38 by the injector 36.

In summary, the injector controller preferably is configured to initiate the predetermined injection sequence during the predetermined time period. Also, it is preferred that the injector 36 locates the preselected number of the bales in the column at least partially in the chute 38 during the predetermined time period.

After the bale bundle 112 has been formed, the rear door 66 is opened to open a rear opening, and the bale bundle 112 may then exit from the compression chamber 28 via the rear opening, in the direction generally indicated by arrow “F” in FIG. 6B. Preferably, a ramp 70 is provided for moving the bale bundle 112 from the compression chamber 28 to the ground. For clarity of illustration, a ground surface is identified in the drawings by reference character “G”.

In one embodiment, the formed bale bundle 112 preferably is pushed gradually out of the compression chamber 28, through the rear opening, by the first columns of bales that are intended to form part of the next bale bundle. As described above, each column of the bales is pushed in turn from the loading chamber 26 into the compression chamber 28.

For example, after a bale bundle is formed, the first column of the following bale bundle is moved to the predetermined location partly on the floor, at which the first column is supported by the floor 64 above the chute 38. Subsequent columns (e.g., the second column, and subsequent columns, up to the sixth when the bales are standard bales) are pushed into the compression chamber against the previously-formed bale bundle until the previously-formed bale bundle has been pushed sufficiently far out the rear opening that the bale bundle moves down the ramp 70 under the influence of gravity. As a result, the formed bale bundle (i.e., formed of the preceding seven columns) is pushed out the rear opening slowly, only moving initially when a column of bales is pushed from the loading chamber into the compression chamber. In general, once more than approximately one-half of the length of the formed bale bundle extends out the rear opening, i.e., beyond the floor 64, the balance of the bale bundle exits the compression chamber 28 due to the influence of gravity, and the bale bundle then moves down onto the ramp 70, under the influence of gravity.

Once the bale bundle is formed, the rear door 66 is released. From the foregoing, it can be seen that once the bales bundle is formed, it may exit the compression chamber only gradually at first, i.e., as each successive column of the next bale bundle is pushed into the compression chamber 28. Accordingly, during this time period, the rear door 66 preferably remains open. It will be understood that the rear door preferably remains open until the final movement step in the predetermined assembly sequence is commenced.

As schematically illustrated in FIG. 5B, the system 20 preferably includes a door control subassembly 96 that includes a motion device 97 that is controlled by a door controller 98. The door controller 98 is configured for communication with the system controller 53 (FIG. 7).

It will be understood that the motion device 97 may be any suitable device for moving the door 66 between its open and closed positions. In one embodiment, for example, the motion device 97 may be a hydraulic cylinder.

The door controller 98 responds to signals transmitted to it from the system controller 53. For example, when the bales are standard bales, the system controller 53 transmits a signal to the door controller 98 to cause the motion device 97 to move the rear door 66 to the closed position thereof, when the sixth stroke of the plunger in the predetermined assembly sequence commences.

Once the rear door 66 is closed, the plunger may complete the predetermined assembly sequence for the bale bundle, i.e., the plunger compresses the columns in the final step, to allow the knotter 46 to tie the columns together to form the new bale bundle. After the knotter 46 has completed tying the columns together to form the bale bundle, in response to a signal from the knotter controller 47, the system controller 53 transmits a signal to the door controller 98 that causes the motion device 97 to move the door 66 to its open position.

It will be understood that, when the system controller 53 causes the rear door 66 to be opened, the plunger returns to its home position, to commence the next predetermined assembly sequence.

It is preferred that the ramp 70 includes rollers thereon, so that the formed bale bundle, once positioned on the ramp 70, will move down the ramp 70 easily until the bale bundle at least partially rests on the ground “G”, but also partly is supported by the ramp 70. Those skilled in the art would appreciate that the part of the bale bundle that remains on the ramp 70 preferably is gently lowered to the ground “G” due to the generally forward movement of the system 20.

### Large Bales Example—Injector

As noted above, the examples illustrated in the drawings show standard bales, and it is preferred that three standard bales are included in a column that is positioned in the loading chamber 26 by the injector assembly 34, before the column is moved into the compression chamber 28 by the plunger assembly 42. As is also noted above, however, where the bales are large bales, the column positioned in the loading chamber by the injector assembly preferably includes only two large bales.

Accordingly, where the bales are “large”, the preselected series of steps in the predetermined injection sequence preferably includes only two steps.

As is also noted above, it is preferred that, where the bales are large bales, only the first bale is positioned with a first short stroke of the injector in the chute 38, and held therein by the one or more dogs 52. Preferably, the one or more dogs 52 are located at the lower end 88 of the chute wall 39. Accordingly, the first bale to be included in a column of two large bales may be positioned in the chute 38, supported by the one or more dogs 52, without the first bale in the chute 38 interfering with the operation of the plunger 44 across the loading chamber 26.

With a longer second stroke of the injector, a second large bale is pushed into the chute, where it engages the first bale, and then both of the two large bales are pushed further up the chute 38 by the injector, and into the loading chamber 26. It will also be understood that the injector blade 50 remains in its extended position, supporting both of the large bales in the column in the loading chamber 26, until the column is moved by the plunger 44 to the predetermined location on the floor 64 at which the floor 64 supports the column above the chute 38. At that point, due to the data from the plunger rotational potentiometers 54 transmitted to the plunger controller 48, and due to a suitable signal from the plunger controller 48 to the system controller 53, the system controller 53 transmits a signal to the injector controller 40 causing the injector 36 to be moved from its extended position to its home position, where the injector may commence the next predetermined injection sequence.

From the foregoing, it can be seen that, where the bales are “large” bales, the predetermined number of bales (“N”) in a column is two. Also, the preselected number of “large” bales in the column while it is being formed (“N−1”) is one.

Standard Bales Example—Injector Operation while Plunger Compresses

As noted above, once the plunger 44 has located the column of three standard bales at the predetermined location on the floor 64, so that the floor 64 supports the column above the chute 38 (FIG. 5C), the system controller 53 causes the injector blade 50 to be moved from its extended position to its home position (FIG. 1C). The predetermined injection sequence is repeated until the seven columns of standard bales are located in the compression chamber 28. At that point, the plunger 44 is moved to its extended position, to compress the seven columns against the rear door 66.

It will be understood that, while the plunger 44 is moved to its extended position and also subsequently held in its extended position for the predetermined time period, the injector 36 preferably moves the first and second standard bales of the first column of the next bale bundle into the chute 38. As described above, the first and second bales of the first column may be positioned in the chute 38 (FIG. 3C) without impeding or affecting the operation of the plunger assembly 42. This advantage is due to the size of the chute 38 (in which two standard bales are receivable, without interfering with movement of the plunger 44 across the loading chamber) and the location of the one or more dogs 52 at the lower end 88 of the chute wall 39. Advantageously, the system 20 simultaneously completes tying the columns in the bale bundle together (i.e., with the knotter 46) while positioning the first and second standard bales of the first column of the next bale bundle in the chute 38, thereby expediting the preparation of the bale bundles 112.

In order for the chute 38 to be able to accommodate the first two standard bales of a column (i.e., so that the first two bales in the chute do not interfere with the movement of the plunger 44), the rotary table 32 is positioned relatively low to the ground. The lower end 88 of the chute wall 39 is located proximal to the table 32. One consequence of this is that a drive subassembly (not shown) for rotating the table about the axis “X” (FIG. 1C) preferably is positioned above the table 32.

Another advantage of a relatively low rotary table 32 is that the vertical distance “V” that a pick-up assembly 72 is required to move the bales (i.e., to move the bales off the ground surface “G” and onto the rotary table 32) is a relatively short distance (FIG. 1C).

It will be understood that the plunger controller 48 is configured to count the steps of the preselected series of steps in the predetermined assembly sequence that are taken by the plunger 44. This is done based on data from the plunger rotational potentiometers 62. For the purposes hereof, the preselected number of columns to be moved by the plunger 44 in the predetermined assembly sequence is referred to as “Q”. For example, where the bales are standard bales, “Q” (i.e., the preselected number of the bales in the bale bundle) is seven.

From the foregoing, it can also be seen that the first steps in the predetermined assembly sequence (also referred to as “movement steps”) differ from the single final step of moving the final column into the compression chamber, and compressing the preselected number of columns. For the purposes hereof, the preselected number of columns but one (“Q−1” columns) is referred to as the predetermined number of columns. For example, where the bales are standard bales, the predetermined number of the columns (“Q−1”, i.e., the preselected number of the columns of the bales minus one) is six. In these circumstances, it will be understood that the plunger's stroke for each of the first six columns in a bale bundle that is being formed is the same for each column. That is, for each of the six columns, the plunger 44 has a stroke sufficient to move the column to the predetermined location on the floor 64, at which the column is supported above the chute by the floor 64.

The general relationship between the short strokes of the plunger in the movement steps and the final, longer stroke in the predetermined assembly sequence, where the bales are standard bales, is schematically illustrated in FIG. 9B.

Accordingly, when the bales are standard bales, the final stroke of the plunger for a bale bundle that is being formed is the seventh stroke. As described above, the final stroke is a longer stroke, in which the seventh column is pushed into the compression chamber against the columns previously moved there, and the plunger 44 preferably is then held in its extended position to compress all seven columns for the predetermined time period.

### Large Bales Example—Plunger

As noted above, where the bales are large bales, the bale bundle preferably includes only six columns of large bales, and each of the columns includes only two large bales. That is, the preselected number of columns of large bales in the bale bundle is six.

Accordingly, where the bales are “large”, the preselected series of steps in the predetermined assembly sequence preferably includes only six steps in total. In each of the first five steps, the column in the loading chamber is moved a relatively short distance, to a location at which the column is supported by the floor 64 above the chute 38. In the sixth step, the plunger 44 pushes the sixth column against the others and is moved to an extension position, to compress all six columns.

When the bales are large bales, “Q” (i.e., the preselected number of columns) is six. The predetermined number of columns (“Q−1”, i.e., the preselected number of the columns of the bales minus one) is five.

From the foregoing, it can be seen that, where the system 20 is to process the large bales, the plunger controller 48 preferably is configured accordingly. Due to signals from the system controller 53 sent to the plunger controller 48, the plunger controller 48 causes the plunger 44 to push each of the first five columns for the bale bundle to be formed the same, relatively short, distance, i.e., a distance sufficient to locate each column in the compression chamber 28 at a location (i.e., the predetermined location on the floor) where each respective column is, in turn, supported by the floor 64 above the chute 38.

As noted above, data from the plunger rotational potentiometers 62 provided to the plunger controller 48 enables the plunger controller 48 to count the strokes of the plunger 44. Once all five short strokes have taken place, the next stroke is the final, and long stroke.

Preferably, the plunger controller 48 causes the plunger 44 to push the sixth column into the compression chamber 28 with a relatively longer stroke, to compress the six columns against the rear door 66. Also, the plunger 44 is held in its extended position for a predetermined time period, which is sufficient to enable the knotter 46 to tie the columns together, to form the bale bundle. It will also be understood that the tying assembly 46 is activated by an activation signal transmitted to the knotter controller 47 from the system controller 53, once the plunger 44 is in its extended position.

It will be understood that, once the bale bundle is formed, the rear door 66 is opened, and the bale bundle formed of large bales preferably is pushed out of the rear opening in generally the same way as the bale bundle that is formed of standard bales.

It will be understood that the system 20 may be otherwise adjusted to accommodate different dimensions of the bales and/or the bale bundles. For example, the height of the ceiling 68 relative to the floor 64 may be adjustable. As an example, if the standard bales are utilized in the system 20, but subsequently it is intended to utilize the large bales in the system, then the ceiling's position may be adjusted accordingly. Those skilled in the art would appreciate that the predetermined injection sequence and the predetermined assembly sequence may be amended in order to accommodate bales with different preselected dimensions and bale bundles with different predetermined dimensions.

### Pick-Up Assembly

In one embodiment, the intake assembly 30 preferably includes the pick-up assembly 72, which is formed to pick up bales off the ground “G” as the system 20 moves forward (i.e., in the direction indicated by arrow “A” in FIG. 8A), moving each bale partly rearwardly and partly upwardly, as indicated by arrow “T” in FIG. 8B. As the system 20 moves forwardly, each bale on the ground is grabbed in turn by drive rollers 74 (FIGS. 8B, 8C) to propel each bale individually up a channel 82 defined between intake walls 80 and subsequently onto the rotating table 32 (FIG. 8C).

In one embodiment, the pick-up assembly 72 preferably includes two drive rollers 74 and one driven roller 6 mounted in each of the intake walls 80 (FIGS. 8B, 8C). The pick-up assembly 72 moves each of the bales up, over the vertical distance “V” from the ground “G” to the table 32 (FIG. 1C).

As noted above, the table 32 rotates while the system 20 is operating. Once the bale is on the rotating table 32, it is moved by the table to the engagement location thereof on the table, relative to the injector blade 50, as described above (FIG. 1C). As noted above, when the injector blade 50 is in its home position, the injector blade 50 is positioned for engagement with the bale that is in the engagement location (FIG. 1C). It will be understood that the bale may be held in the engagement location by a stop device while the rotating table 32 continues to rotate, so that the table slides underneath the bale that is in the engagement location.

As described above, it is preferred that each of the bales is in the predetermined orientation when the bale is in the engagement location on the table 32. When the bale in the engagement location is in the predetermined orientation, one of the bale's sidewalls is positioned for engagement by the injector blade 50, and the top wall is facing upwardly (FIG. 1C). Preferably, the pick-up assembly 72 delivers each bale individually, in succession, to the engagement location in the predetermined orientation.

The pick-up assembly 72 preferably includes arms 84 that extend outwardly, in front of the intake walls 80 (FIGS. 8B, 8C). It will be understood that as the system 20 is moved across a field in the forward direction (FIG. 8A), the bales on the ground in the field are individually and in succession engaged by the pick-up assembly 72. Preferably, the arms 84 are formed to guide each bale into the channel 82 in succession, end wall first. Those skilled in the art would appreciate that, if the bale when first engaged by the arms 84 is not aligned with its end wall facing toward the channel 82, then the bale preferably is guided into the channel 82, end wall first, by the arms 84, due to the forward motion of the system 20 relative to the ground.

In summary, the bales preferably are individually picked up by the pick-up assembly 72 oriented with the end wall thereof leading in each case, so that each bale will be positioned in the engagement location on the table with each bale's end wall leading (i.e., in the predetermined orientation), one after another. As described above, the bale that is so oriented when in the engagement location (referred to above as the predetermined orientation of the bale in the engagement location) is moved by the injector 36 from the table 32 and ultimately positioned in the loading chamber 26 in a column, in which the bale is in the preferred orientation.

For the purposes hereof, the orientation of the bale moving through the channel with an end wall of the bale leading, and sidewalls of the bale engaged by the rollers, is referred to as the “preselected orientation”.

The drive rollers 74 and the driven rollers 6 preferably are mounted on resilient mount assemblies 75 (FIG. 8C), which enable the drive rollers 74 and the driven rollers 6 to engage the sidewalls of the bales moving through the channel 82 with suitable pressure.

In one embodiment, the drive rollers 74 preferably are rotated about their respective axes “Y” by one or more suitable power sources. For example, each drive roller 74 may be driven by a suitable hydraulic or electric motor “M”. For clarity of illustration, only one axis of rotation “Y” is identified, in FIG. 8A. Those skilled in the art would be aware that the motors “M” may be activated in any suitable manner. For example, in one embodiment, the motors “M” preferably are continuously activated while the system 20 is moving across a field, to pick up the bales.

Preferably, the intake walls 80 are positioned parallel (or substantially parallel) to each other. It will be understood that the drive rollers 74 and the driven rollers 6 are sized and positioned so that each bale in the preselected orientation moving through the channel is squeezed by the rollers at its sidewalls to a limited extent when the rollers engage the bale, so that the rollers may move each of the bales along the channel 82, and ultimately onto the rotating table. It is preferred that the drive rollers 74 and the driven rollers 6 are positioned in the intake walls opposite to each other, in the respective intake walls 80.

In one embodiment, the pick-up assembly 72 preferably includes a top guide 86 (FIG. 8C), for holding bales in the channel 82 as they are moving through the channel 82.

As can be seen in FIG. 8C, in one embodiment, the pick-up assembly 72 preferably includes a floor 76. It will be understood that the floor 76 is for providing structural support to the intake walls 80, locating them to define the channel therebetween. The bales are engaged by the drive rollers 74 and the driven rollers 6 and moved thereby along the channel 82. Preferably, the bales are generally not supported by the floor 76 as the bales are moved through the channel 82, but instead are supported by the rollers. Those skilled in the art would appreciate that the floor 76 may include, for example, bars, rollers, screens, or a plate.

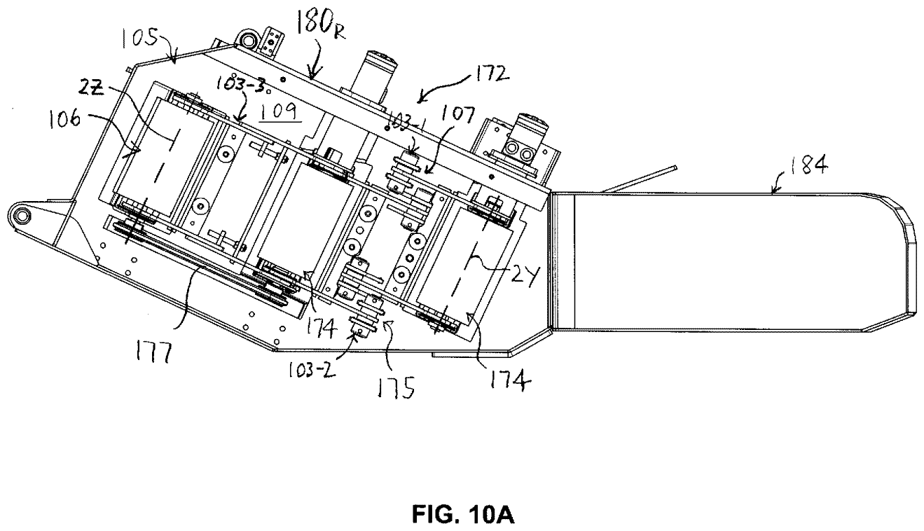

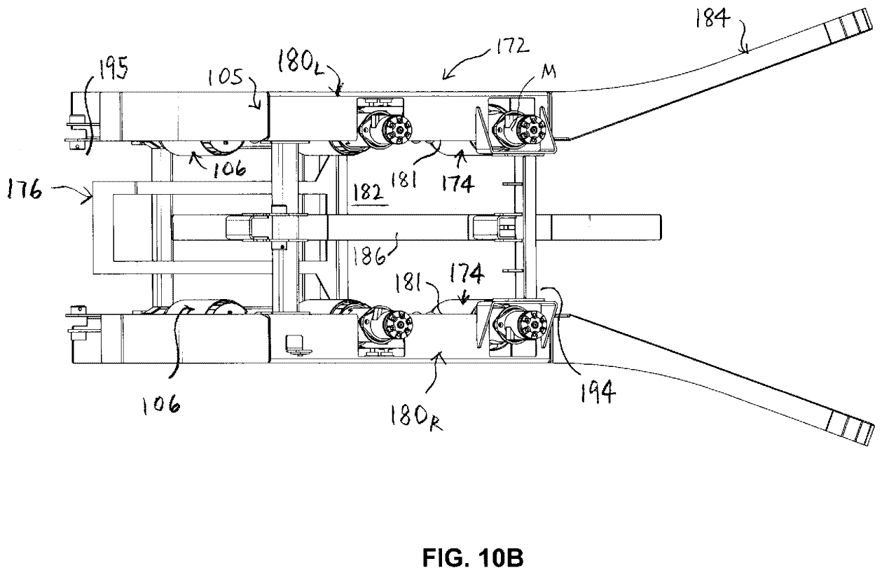

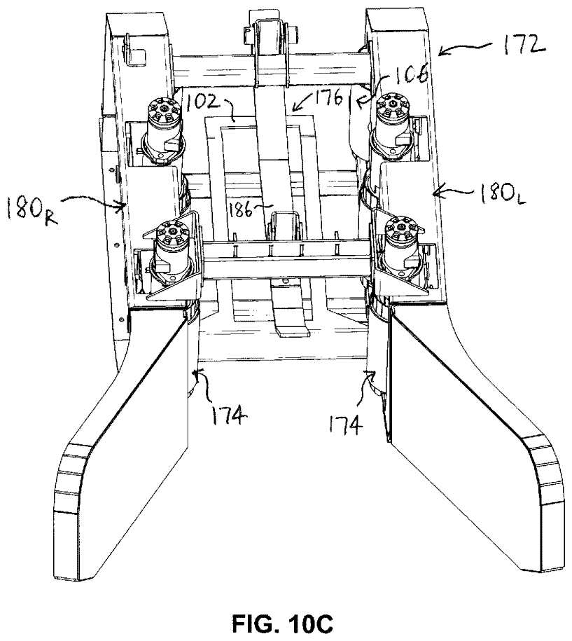

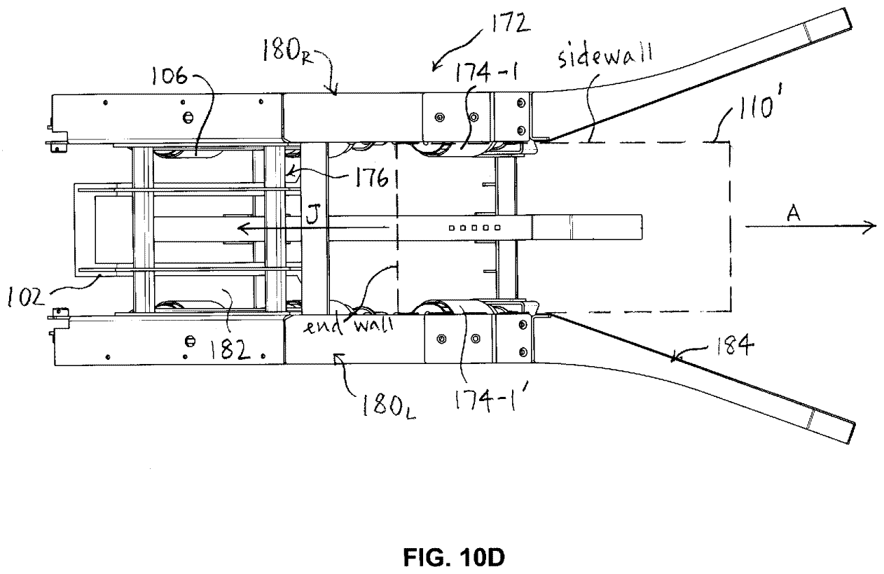

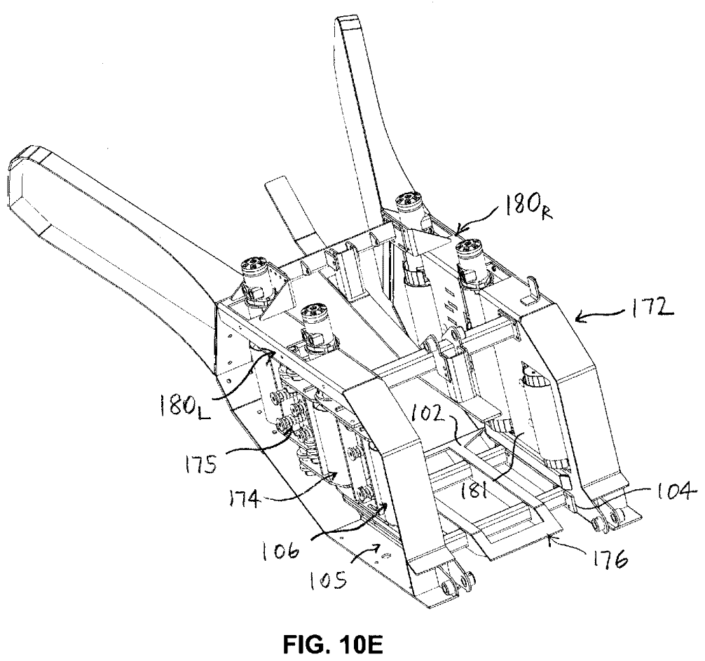

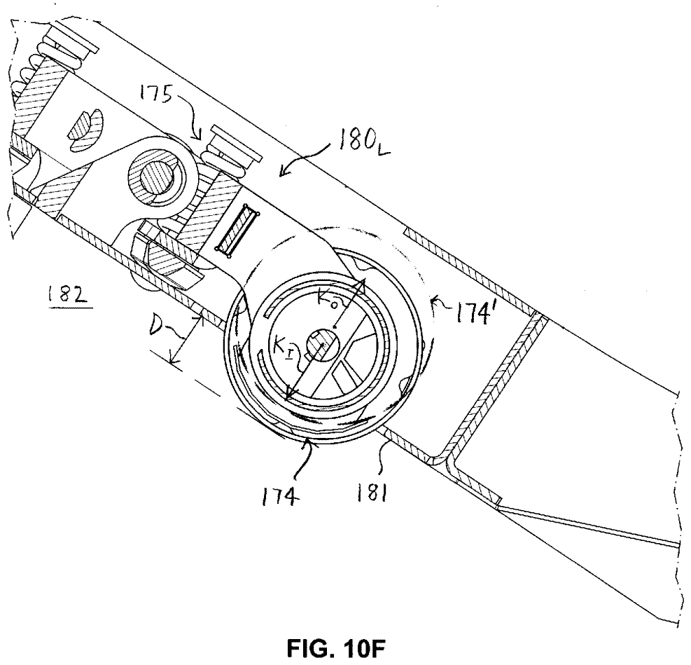

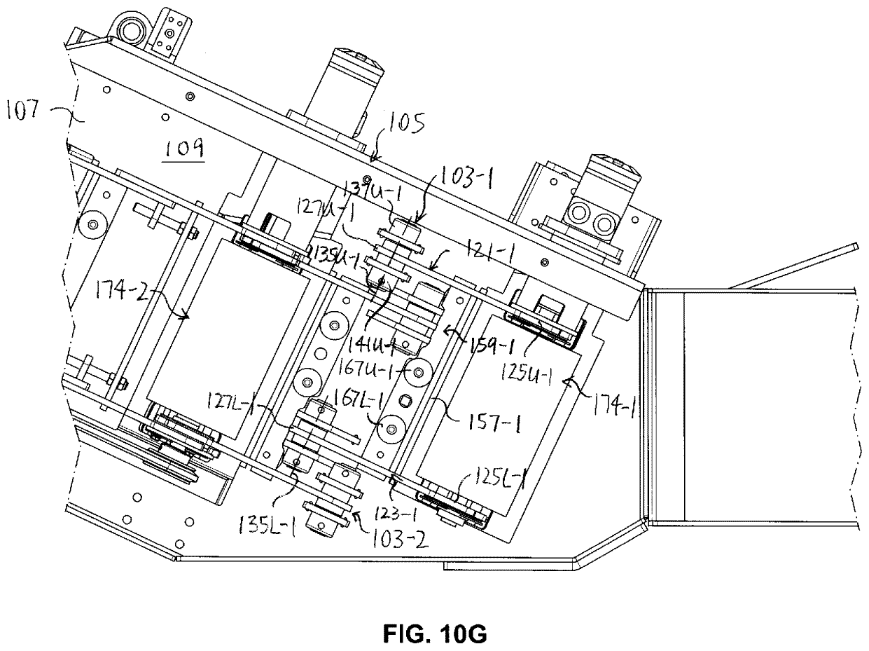

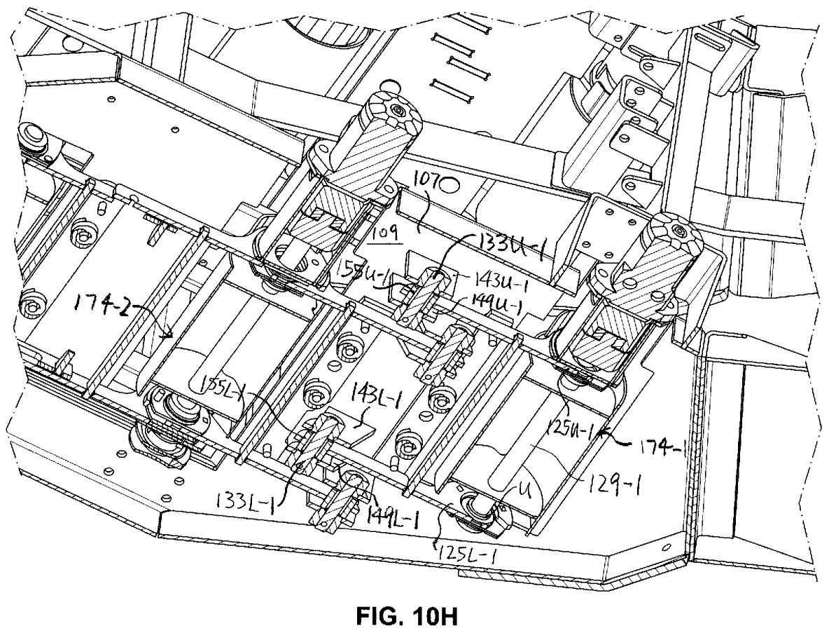

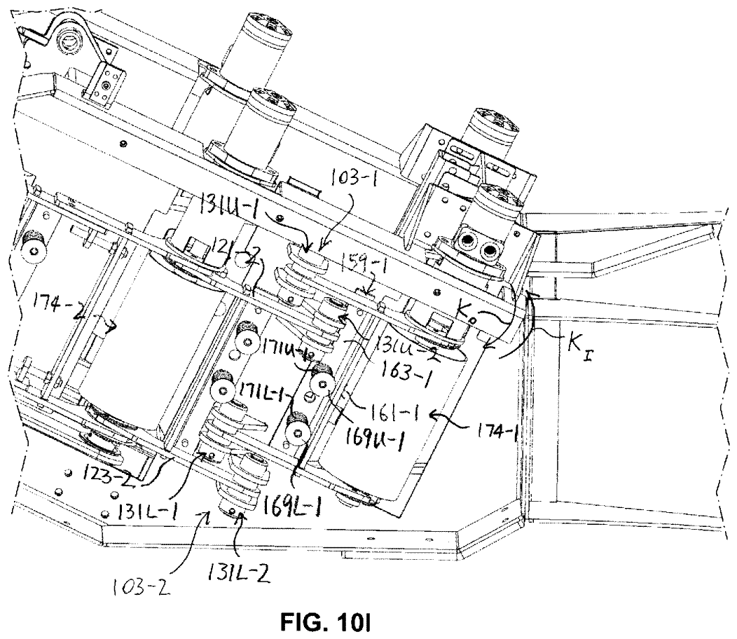

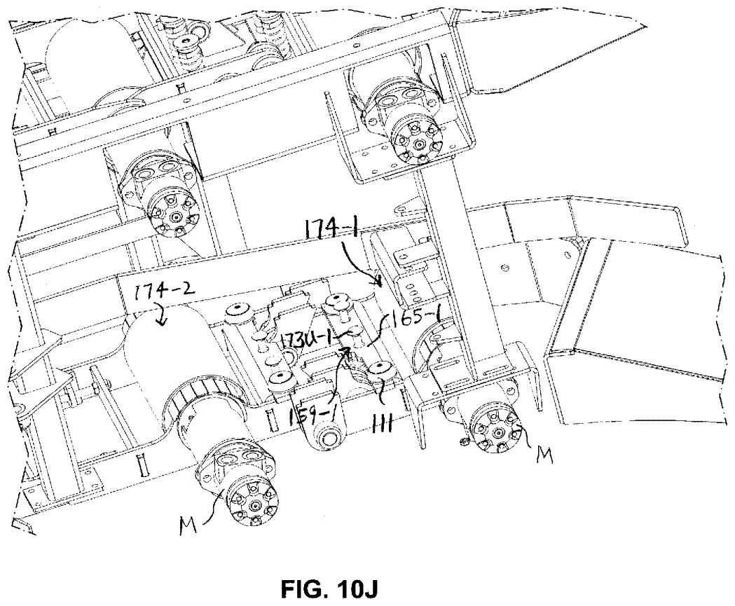

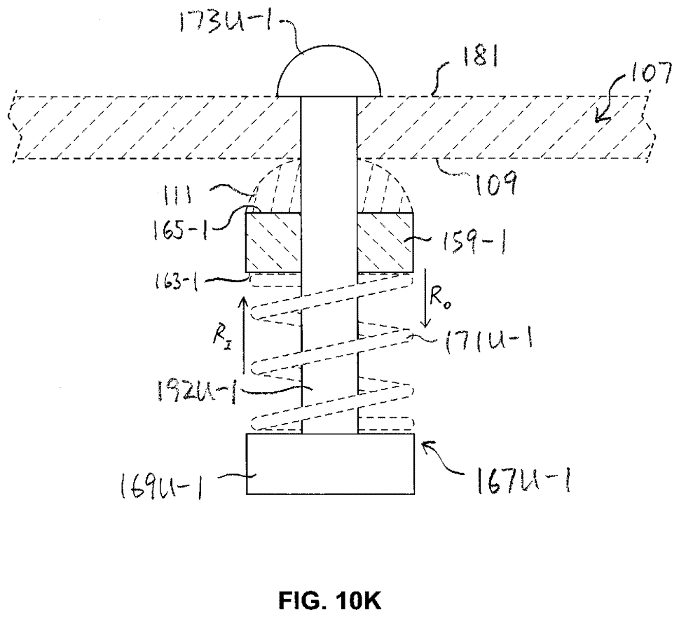

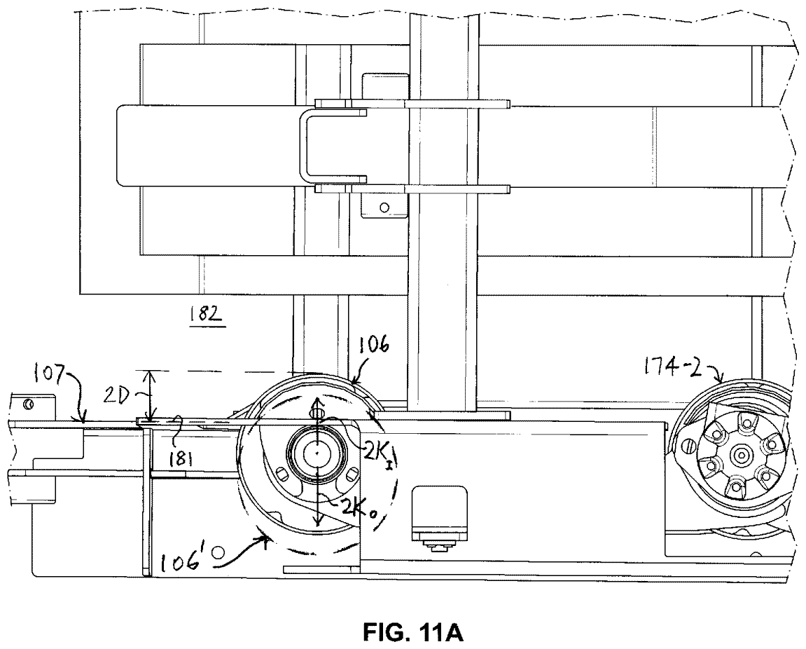

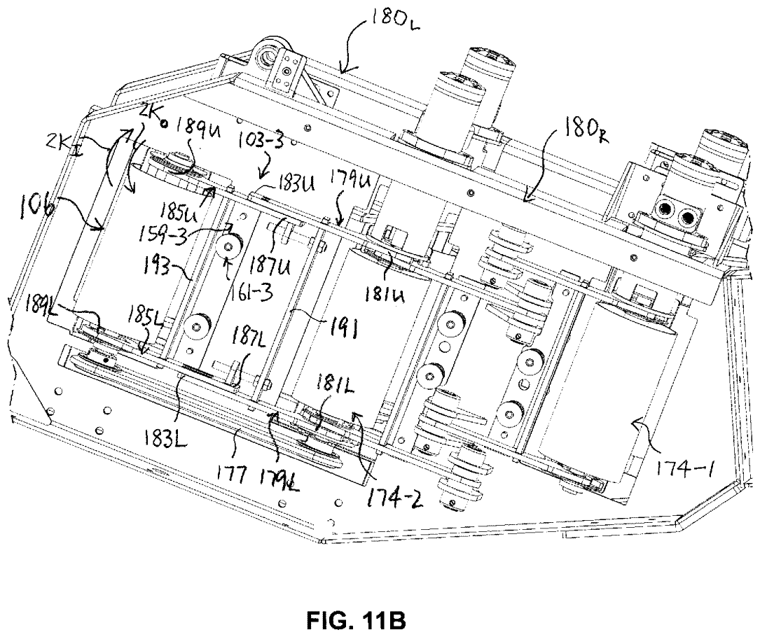

An alternative embodiment of the pick-up assembly 172 of the invention is illustrated in FIGS. 10A-11B. In this embodiment, the pick-up assembly 172 preferably includes a floor 176 having one or more base elements 102 (FIGS. 10D, 10E) that extend between left and right intake walls 180L, 180R of the pick-up assembly 172, at the bottom sides 104 thereof (FIG. 10E).

As can be seen, e.g., in FIGS. 10C-10E, the base elements 102 may be metal strips or bars that provide structural support to the left and right intake walls 180L, 180R. Preferably, the base elements 102 are bars or screens or other elements that do not permit dirt or debris to accumulate thereon.

In one embodiment, the pick-up assembly 172 preferably includes two drive rollers 174 and a driven roller 106 mounted in each of the left and right intake walls 180L, 180R. It will be understood that the driven rollers 106 are each driven by an adjacent drive roller 174. Each drive roller 174 is rotatable about an axis “2Y” thereof, and each driven roller 106 is rotatable about an axis “2Z” thereof (FIG. 10A).

As can be seen, for example, in FIGS. 10A-10C, the drive rollers 174 preferably are mounted in the left and right intake walls 180L, 180R opposite to each other, so that each bale is engaged by the drive rollers 174 on opposite sides of a channel 182 defined by the intake walls 180L, 180R at the same time (or at substantially the same time) when the bale moves through the channel 182, for maximum effectiveness (FIG. 10B). The driven rollers 106 are also preferably positioned in the left and right intake walls, opposite each other (FIG. 10B).

As can be seen in FIG. 10B, the channel 182 extends between an input end 194 thereof, at which each bale enters the channel 182, and an output end 195 thereof, at which each bale exits the channel 182. Preferably, when the pick-up assembly 172 is mounted at the front end of the system 20, the pick-up assembly 172 is positioned so that the bales exiting at the output end 195 are located on the table 32 of the system 20.

The pick-up assembly 172 preferably also includes a top guide 186, for holding the bales in the channel 182 as they are moving through the channel 182 (FIGS. 10B, 10C).

The intake walls 180L, 180R preferably have respective bodies 105 that each include wall elements 107 that have relatively smooth interior surfaces 181 thereof facing inwardly (defining the channel 182), to facilitate movement of the bales through the channel 182 (FIG. 10B). The wall elements 107 also include respective exterior surfaces 109 opposite to the interior surfaces 181 of the wall elements 107 (FIG. 10A). It will be understood that the wall element 107 in an intake wall may not be continuous, but may include separate wall element segments.

The pick-up assembly 172 preferably includes one or more resilient mount assemblies, generally indicated by reference character 175 in FIGS. 10A and 10E, that are mounted in the intake walls 180L, 180R to allow each of the drive rollers 174 and the driven rollers 106 mounted thereto to move between an inward position and an outward position thereof. As will be described, the resilient mount assemblies 175 preferably are biased to urge the drive rollers 174 and the driven rollers 106 to their respective inward positions.

In each intake wall, the rollers 174, 106 are mounted to the resilient mount assembly 175, and the resilient mount assembly 175 preferably is mounted to the wall element 107 of the body 105 of the intake wall, as will be described.

The resilient mount assembly 175 that is mounted in the right intake wall 180R will now be described in detail. It will be understood that the drive rollers in the right intake wall 180R are identified in FIGS. 10G-10J and 11B by reference characters 174-1 and 174-2 for convenience.

The resilient mount assembly 175 in each of the left and right intake walls 180L, 180R preferably includes one or more resilient mount subassemblies, i.e., one resilient mount subassembly for each of the rollers in the intake wall. For example, as will be described, three resilient mount subassemblies are identified by reference characters 103-1, 103-2, 103-3 that are mounted in the right intake wall 180R. The three resilient mount subassemblies 103-1, 103-2, 103-3 are mounted to the wall element 107 of the body 105 of the intake wall 180R. As will be described, the drive rollers 174-1, 174-2 and the driven roller 106 in the right intake wall 180R are mounted to the respective resilient mount subassemblies 103-1, 103-2, 103-3 in the intake wall 180R (FIGS. 10G-10J, 11B).

Preferably, in their respective inward positions, each of the drive rollers 174 extends into the channel 182 beyond the interior surface 181 by a preselected relatively small distance “D” (FIG. 10F). As noted above, due to the movement of the system 20 in the forward direction, the bales are individually and in succession guided by the arms 184 into the channel 182, with the end walls of the bales leading.

It will be understood that the arms 184 preferably guide each bale into the preselected orientation and into the channel as the pick-up assembly 172 is moved forward relative to the ground, i.e., in the direction indicated by arrow “A” in FIGS. 1C, 8A, and 10D. When a bale in the preselected orientation begins to enter the channel 182 (due to the system's forward motion), the sidewalls of the bale are engaged by the drive rollers 174, to move the bales up the channel 182, until the bales are deposited on the table 32 by the pick-up assembly 172.

A bale 110′ is outlined in dashed lines in FIG. 10D. In the example shown in FIG. 10D, the bale 110′ is shown in the preselected orientation, partly in the channel 182, and the sidewalls of the bale 110′ are engaged by drive rollers 174-1 and 174-1′. The bale 110′ is shown only partially located in the channel 182 in FIG. 10D, i.e., in the example shown in FIG. 10D, the bale 110″ is only beginning to be moved through the channel 182.

It will be understood that, for clarity of illustration, the drive rollers 174-1, 174-1′ are shown in their respective inward positions in FIG. 10D. However, from the foregoing, it will be understood that upon their engagement with the sidewalls, the drive rollers are moved to or toward their respective outward positions.

From the foregoing, it can be seen that the rollers in the pick-up assembly 172 engage the sidewalls of the bale 110′, and move the bale 110′ toward the table 32 (not shown in FIG. 10D), i.e., in the direction indicated by arrow “J” in FIG. 10D.

It will be understood that the pick-up assembly 172 preferably is included in a bale stacker system that is moved forwardly relative to the ground, on which the bales to be picked up are located (i.e., in the direction indicated by arrow “A” in FIG. 10D).

In FIG. 10F, a drive roller 174 mounted in the left intake wall 180, is shown in its inward position in solid outline. The drive roller that is shown in dashed outline in FIG. 10F, which is identified by reference character 174′ for clarity of illustration, represents the drive roller in its outward position. It will be understood that the inward and outward positions are, respectively, the furthest inward position and the furthest outward position of the roller that are permitted by the resilient mount subassembly for the roller. That is, the roller that is in its inward position is positioned partly in the channel, to the greatest extent permitted by its resilient mount subassembly. When the roller is in its outward position, the roller is positioned as far away from the channel as permitted by its resilient mount subassembly to which it is mounted. It will also be understood that the roller is pushed outwardly, i.e., away from its inward position and to or toward its outward position, by the bale, when the roller engages the sidewall of a bale.

Because the resilient mount assembly 175 in each intake wall is biased to urge each of the rollers to their respective inward positions, the rollers on both sides of the bale tend to squeeze the bale between them. Also, because the rollers are rotating about their respective axes, the rollers cause the bale caught between them to move relatively quickly up the channel 182.

For example, as can be seen in FIG. 10F, when the bale (not shown in FIG. 10F) engages the roller 174, the bale urges the roller 174 in the direction indicated by arrow “K_{O}”, i.e., outwardly, toward the roller's outward position. It will be understood that, after the bale is moved past the roller 174, the resilient mount assembly 175 (only partly shown in FIG. 10F) moves the roller 174 in the direction indicated by arrow “K_{I}”, i.e., inwardly, to or toward the roller's inward position. When the roller is in its inward position, it is ready to be engaged by the next bale moving through the channel 182.

As noted above, the outward position of the drive roller 174′ shown in FIG. 10F represents the furthest outward location of that roller that is possible. It will be understood that the difference between the inward and outward positions of the drive roller is exaggerated in FIG. 10F, for clarity of illustration.

An exterior or outer surface 109 of the right intake wall 180_{R} can be seen in FIGS. 10A and 10G. As noted above, the drive rollers mounted in the intake wall 180_{R} are identified by reference characters 174-1 and 174-2 in FIGS. 10G-10J and 11B for convenience, and the resilient mount assembly 175 mounted to the intake wall 180_{R} preferably includes separate resilient mount subassemblies, identified in FIG. 10A by reference characters 103-1, 103-2 for convenience, to which each of the drive rollers 174-1, 174-2 is mounted respectively.

As noted above, the drive rollers 174-1, 174-2 are mounted only to the respective resilient mount subassemblies 103-1, 103-2 therefor. The resilient mount subassemblies 103-1, 103-2 are both secured to the body 105 of the intake wall 180_{R}, i.e., to the wall element 107 thereof. Accordingly, each of the drive rollers 174-1, 174-2 is indirectly mounted to the wall element 107, via the resilient mount subassemblies 103-1, 103-2 respectively.

Of the resilient mount subassemblies 103-1, 103-2, only the resilient mount subassembly 103-1 will be described in detail. It will be understood that the resilient mount subassemblies 103-1 and 103-2 are mirror images of each other, and otherwise the same in all relevant respects, related to the drive rollers 174-1, 174-2 respectively. The resilient mount subassembly 103-3 is further described below.

As can be seen in FIG. 10G, the resilient mount subassembly 103-1 preferably includes upper and lower arms 121-1, 123-1, each extending between a respective roller end 125U-1, 125L-1 thereof and a respective anchor end 127U-1, 127L-1 thereof. It will be understood that each of the roller ends 125U-1, 125L-1 preferably includes a bearing “U” (FIG. 10H) that is mounted onto an axle 129-1 of the roller 174-1 (FIG. 10H). The axle 129-1 defines the axis “2Y” about which the drive roller 174-1 rotates.

Preferably, the resilient mount subassembly 103-1 includes an upper anchor pin subassembly 131U-1 and a lower anchor pin subassembly 131L-1 (FIG. 10I). As can be seen in FIG. 10H, the upper anchor pin subassembly 131U-1 preferably includes an upper anchor pin 133U-1 that defines an axis 135U-1 of the upper anchor pin subassembly 131U-1 (FIG. 10G). The lower anchor pin subassembly 131L-1 preferably includes a lower anchor pin 133L-1 that defines an axis of the lower anchor pin subassembly 131L-1 (FIG. 10G).

It will be understood that each of the upper and lower anchor pins 133U-1, 133L-1 are not rotatable about their respective axes. Instead, the pin 133U-1 preferably is at least partly held in place by first and second caps 137U-1, 141U-1 that are secured to the pin (FIGS. 10G, 10H). The caps 137U-1, 141U-1 are also respectively secured to plates 143U-1, 149U-1, that are secured to the exterior surface 109 of the wall element 107.

The pin 133L-1 preferably is also held in place by first and second caps 137L-1, 141L-1 that are secured to the pin 133L-1 (FIGS. 10G, 10H). The caps 137L-1, 141L-1 are also secured to plates 143L-1, 149L-1, which in turn are also secured to the exterior surface 109 of the wall element 107 (FIG. 10H). For example, the plates 143U-1, 143L-1, 149U-1, 149L-1 may be secured to the exterior surface 109 by welding, and the caps may be secured to the plates 143U-1, 143L-1, 149U-1, 149L-1 by welding also.

Preferably, the upper and lower anchor pin subassemblies 131U-1, 131L-1 also each include a sleeve 155U-1, 155L-1 respectively to which the anchor ends 127U-1, 127L-1 are respectively secured, e.g., by welding (FIGS. 10G, 10H). It will be understood that each of the sleeves 155U-1, 155L-1 preferably is rotatable about the respective axes 135U-1, 135L-1.

As can be seen in FIGS. 10G and 10H, it is also preferred that the upper and lower arms 121-1, 123-1 are connected by a connector element 157-1, at locations on the upper and lower arms 121-1, 123-1 that are approximately midway between the ends of the arms 121-1, 123-1 (FIG. 10G). Preferably, at another location approximately midway on the arms 121-1, 123-1, the arms are both connected with a base strip element 159-1 that is included in a spring subassembly 161-1 (FIG. 10I). For example, the arms 121-1, 123-1 may be welded to the base strip element 159-1 at respective upper and lower ends thereof.

The base strip element 159-1 has an exterior side 163-1 (FIG. 10I) and an interior side 165-1 (FIG. 10J). It will be understood that the wall element 107 of the right side intake wall 180R is omitted from FIG. 10J, for clarity of illustration.

As can be seen in FIG. 10I, the spring subassembly 161-1 preferably also includes stop pins 167U-1, 167L-1. Each of the stop pins includes a stop plate 169U-1, 169L-1, and the spring subassembly also includes respective springs 171U-1, 171L-1 (FIG. 10I) that are positioned on the pins 167U-1, 167L-1 between the exterior side 163-1 of the base strip element 159-1 and the respective stop plates 169U-1, 169L-1 (FIGS. 10I, 10K).

Preferably, each of the stop pins 167U-1, 167L-1 includes a head element thereof, formed for engagement with the interior surface 181 of the wall element 107. It will be understood that, for clarity of illustration, only the stop pin 167U-1 and the spring 171U-1 are illustrated in FIG. 10K. It will be understood that the other stop pins and related elements are the same as the stop pin 167U-1 and related elements that are illustrated in FIG. 10K.

A head element 173U-1 of the stop pin 167U-1 is shown in FIG. 10K. As can be seen in FIG. 10K, the pin 167U-1 preferably includes a shaft 192U-1 extending between the stop plate 169U-1 and the head element 173U-1. As can also be seen in FIG. 10K, the shaft 192U-1 preferably extends through the base strip element 159-1.

Preferably, a spacer element 111 is positioned between the base strip element 159-1 and the exterior side 109 of the wall element 107. As can be seen in FIG. 10K, it is preferred that the base strip element 159-1 is held securely against the exterior surface 109 of the wall element 107, i.e., the spacer 111 is pressed against the exterior surface 109 by the spring 171U-1.

The spring 171U-1 is held between the stop plate 169U-1 and the exterior side 163-1 of the base strip element 159-1 (FIG. 10K). Preferably, the spring 171U-1 is a suitable compression spring, sized to push constantly against the stop plate 169U-1 and against the exterior side 163-1 of the base strip element 159-1.

As can be seen in FIG. 10K, the head element 173U-1 preferably engages the interior surface 181 of the wall element 107. Those skilled in the art would appreciate that the spacer 111 is sized to keep the spring 171U-1 under compression while the roller is moved between its inward and outward positions. The spacer 111 preferably is made of a suitable resilient material.

Referring to FIGS. 10G-101, when the drive roller 174-1 is moved from its inward position toward its outward position, the drive roller 174-1 moves the roller ends 125U-1, 125L-1 of the arms 121-1, 123-1 outwardly, i.e., away from the exterior surface 109 of the wall element 107. Such outward movement is schematically represented by arrow “K_{O}” in FIG. 10I. It will be understood that such outward movement is over a relatively small distance, in practice.

The outward movement of the roller ends 125U-1, 125L-1 causes the arms 121-1, 123-1 to pivot about the axes 135U-1, 135L-1 that are defined by the upper and lower anchor pins 133U-1, 133L-1 respectively.

Because the base strip element 159-1 is secured to the upper and lower arms 121-1, 123-1, the outward movement of the roller ends 125U-1 125L-1 of the upper and lower arms 121-1, 123-1 also causes the base strip element 159-1 to move outwardly, i.e., away from the exterior surface 109 of the wall element 107. As can be seen in FIG. 10K, the outward movement of the roller ends 125U-1, 125L-1 therefore urges the base strip element 159-1 to move in the direction indicated by arrow “R_{O}”. However, as described above, the spring 171U-1 constantly urges the base strip element 159-1 in the direction indicated by arrow “R_{I}” in FIG. 10K. Accordingly, in response to any movement of the base strip element 159-1 in the direction indicated by arrow “R_{O}”, the spring 171U-1 pushes the base strip element 159-1 in the opposite direction, i.e., in the direction indicated by “R_{I}” in FIG. 10K.

From the foregoing, it can be seen that, in response to outward movement of the drive roller 174-1, the resilient mount subassembly 103-1 urges the drive roller 174-1 to move back to its inward position, as schematically represented by arrow “K_{I}” in FIG. 10I.

The resilient mount subassembly 103-1 preferably is formed to absorb the sudden movements to which the drive roller 174-1 is subjected due to the bales that bump up against the drive roller 174-1 as the system 20 is moving forwardly across a field, picking up the bales. Because the springs 171U-1, 171L1 dampen the outward movement of the drive roller 174-1 and urge the drive roller 174-1 to its inward position, the pick-up assembly 172 can absorb the bumping and pushing to which the drive rollers are subjected by the bales during normal operation.

As can be seen in FIG. 10G, the pick-up assembly preferably also includes the resilient mount subassembly 103-2 to which the drive roller 174-2 is mounted. It will be understood that the resilient mount subassembly 103-2 includes elements corresponding to those of the resilient mount subassembly 103-1 that function in the same way. Certain elements of the resilient mount subassembly 103-2 are the mirror image of corresponding elements of the resilient mount subassembly 103-1. For clarity of illustration, only the upper and lower arms 121-2, 123-2, the upper and lower anchor pin subassemblies 131U-2, 131L-2, and the base strip element 159-2 of the resilient mount subassembly 103-2 are identified in FIG. 10I.

In FIG. 11A, the driven roller 106 is shown in its inward position in solid outline. When the driven roller 106 is in its inward position, the driven roller 106 extends inwardly from the interior surface 181 of the wall element 107 by a distance “2D” (FIG. 11A). The driven roller that is shown in dashed outline in FIG. 11A, which is identified by reference character 106′ for clarity of illustration, represents the roller in its outward position. The driven roller 106 preferably is mounted to the resilient mount subassembly 103-3 (FIG. 11B), which is biased to urge the driven roller 106 to its inward position, as will be described.

It will be understood that the inward position of the driven roller 106 is the furthest inward position that is permitted by the resilient mount subassembly 103-3. Similarly, the outward position is the furthest outward position of the driven roller 106 permitted by the resilient mount subassembly 103-3. The driven roller 106 is pushed outwardly, i.e., away from its inward position and to or toward its outward position, by the bale, when the driven roller 106 is engaged by the sidewall of a bale that is moving through the channel 182.

It will also be understood that the corresponding driven roller in the left intake wall is positioned opposite to the driven roller 106 that is illustrated in FIG. 11A, so that the two driven rollers both are engaged by the bale moving up the channel between them. The driven rollers in respective intake walls 180L, 180R are driven about their respective axes to move the bale caught between them up the channel.

Referring to FIG. 11A, when the bale (not shown in FIG. 11A) moving in the channel between the two driven rollers engages the driven rollers, the bale urges the driven rollers outwardly. For example, in FIG. 11A, the driven roller 106 is moved in the direction indicated by arrow “2K_{O}”, i.e., toward the driven roller's outward position, when the bale is engaged by the driven roller 106. After the bale is moved past the driven roller 106, because the resilient mount subassembly 103-3 is biased to the inward position, the resilient mount subassembly 103-3 moves the driven roller 106 in the direction indicated by arrow “2K_{I}”, i.e., to, or toward the roller's inward position.

As can be seen in FIG. 11B, in one embodiment, the driven roller 106 and the drive roller 174-2 preferably are operably connected by a belt 177, so that the driven roller 106 is driven by the drive roller 174-2 to rotate about the driven roller's axis “2Z” (FIG. 10A).

The resilient mount subassembly 103-3 will now be described in detail. Preferably, the resilient mount subassembly 103-3 includes first upper and lower arms 179U, 179L, each extending between first and second ends 181U, 181L, 183U, 183L, and second upper and lower arms 185U, 185L that also each extend between first and second ends 187U, 187L, 189U, 189L, thereof. Preferably, the first ends of the first upper and lower arms 179U, 179L are mounted to the axle of the drive roller 174-2 via bearings (not shown). Similarly, the second ends of the second upper and lower arms 185U, 185L are mounted to the axle of the driven roller 106 via bearings (not shown).

It is also preferred that the first upper and lower arms 179U, 179L are connected by a first connector 191. The second upper and lower arms 185U, 185L preferably are also connected by a second connector 193.

The resilient mount subassembly 103-3 preferably also includes the base strip element 159-3 with one or more spring subassemblies 161-3 mounted thereon.

As can be seen in FIG. 11B, in one embodiment, the first upper arm 179U and the second upper arm 185U overlap, and the first lower arm 179L and the second lower arm 185L preferably also overlap. As can be seen in FIG. 11B, the connector 191 connects the first upper and lower arms 179U, 179L directly, and the connector 191 is also connected with the second upper arm at its first end 187U, and with the second lower arm 185L at its first end 187L.

Preferably, the base strip element 159-3 is secured to the second upper and lower arms 185U, 185L.

Outward movement of the driven roller 106 is schematically represented in FIGS. 11A and 11B by arrow “2K_{O}”. It will be understood that when the driven roller 106 is moved outwardly (e.g., because the driven roller is engaged by a bale moving through the channel), the first ends 189U, 189L of the second upper and lower arms 185U, 185L are moved outwardly, i.e., they are moved away from the exterior surface 109 of the wall element 107.

Due to such outward movement, the base strip element 159-3 is urged outwardly (i.e., away from the exterior surface 109 of the wall element 107). However, in the same manner as described above in connection with the resilient mount subassembly 103-1, the spring subassemblies 161-3 urge the base strip element 159-3 in the other direction, i.e., toward the exterior surface 109. As a result, the spring subassemblies 161-3 dampen the outward movement of the driven roller 106, and urge the driven roller 106 to the inward position thereof, as indicated by arrow “2K_{I}” (FIGS. 11A, 11B).

It will be understood that because the resilient mount assembly 175 in the left intake wall 180_{L} is a mirror image of the resilient mount assembly 175 located in the right intake wall 180_{R}, further description of the resilient mount assembly 175 in the left intake wall 180_{L} is unnecessary.

The pick-up assembly 172 may be used to pick up bales and to position them in a predetermined destination location in any sort of bale processing system, or structure or vehicle in which the bales are to be received. That is, the pick-up assembly 172 may be utilized with any receptacle other than the system 20 described above, to pick up the bales and position them in the predetermined destination location in such structure. The pick-up assembly 172 moves the bales individually off the ground and raises the bales in the preselected orientation to the predetermined destination location, where each bale is located in a predetermined orientation.

Those skilled in the art would also appreciate that the embodiment of the system 20 that is illustrated in the drawings (e.g., in FIGS. 8A-8C) is not self-propelled, but instead is configured to be towed by another vehicle (i.e., a tractor) with a power take-off that may be utilized by the system 20. However, it will be understood that, in an alternative embodiment, the system 20 may be self-propelled.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. A system (20) for forming a bale bundle (112) that includes a preselected number of columns (114) of bales (110) having preselected dimensions, each of the columns including a predetermined number of the bales, the system comprising:
a body assembly (22) comprising an intake portion (24), a loading chamber (26), and a compression chamber (28) in fluid communication with the loading chamber (26), the loading chamber (26) being formed to receive the predetermined number of the bales in each said column respectively;
the compression chamber being partially defined by a floor (64) thereof, and formed to receive the preselected number of the columns of the bales therein;
an intake assembly (30) at least partially positioned in the intake portion (24), the intake assembly comprising a table (32) on which each said bale is individually positioned at an engagement location, in succession;
an injection assembly (34) at least partially positioned in the intake portion (24), the injection assembly comprising an injector (36) and an injector controller (40) for causing the injector to move the predetermined number of the bales individually in succession in a predetermined injection sequence from the engagement location into a chute (38) that is in fluid communication with the loading chamber; and
upon commencing the predetermined injection sequence, the injector controller (40) causes the injector (36) to move a preselected number of the bales in the column into the chute, in which the preselected number of the bales are receivable, the preselected number of the bales being equal to the predetermined number of the bales in the column but one.

2. The system according to claim 1 in which the chute (38) is defined by at least one chute wall (39) that extends between a lower end (88) located proximal to the table (32) and an upper end (89) located proximal to the loading chamber (26).

3. The system according to claim 2 additionally comprising at least one dog assembly (52) positioned at the lower end of the chute wall, for supporting the preselected number of bales in the chute (38).

4. The system according to claim 2 in which, in the predetermined injection sequence, the injector (36) moves each of the preselected number of the bales into the chute over a short injection distance.

5. The system according to claim 4 in which the short injection distance is the distance an injector blade (50) of the injector (36) travels when the injector moves from a home position thereof, in which the injector blade is located for engagement with the bale positioned at the engagement location, to a delivery position thereof, in which the injector blade positions the bale in the chute.

6. The system according to claim 5 in which:
after the preselected number of the bales in the column is located in the chute, the injector controller causes the injector to move a final bale to be included in the column in the predetermined injection sequence from the engagement location to engage with the preselected number of the bales in the chute, and then to push the predetermined number of the bales in the column into the loading chamber, in a long stroke of the injector (36), to form the column of the bales in the loading chamber.

7. The system according to claim 6 in which, in the long stroke of the injector (36), the injector (36) moves from the home position thereof, in which the injector blade (50) is located for engagement with the bale positioned at the engagement location, to the delivery position thereof, in which the injector blade supports the predetermined number of bales in the column in the loading chamber.

8. The system according to claim 7 additionally comprising:
a plunger assembly (42) comprising a plunger (44) and a plunger controller (48) configured to cause the plunger to move the preselected number of the columns of the bales individually in succession from the loading chamber into the compression chamber in a predetermined assembly sequence, in which:
the plunger moves a predetermined number of the columns of the bales into the compression chamber with respective short strokes of the plunger, the predetermined number of the columns being the preselected number of the columns but one; and
the plunger moves a final column of the bales in the predetermined assembly sequence against the predetermined number of the bales in the compression chamber, wherein upon the preselected number of the columns of the bales being located in the compression chamber, the plunger controller causes the plunger to compress the preselected number of the columns of the bales between the plunger and a rear door of the body assembly with a long stroke thereof for a predetermined time period.

9. The system according to claim 8 additionally comprising:
a tying assembly (45) comprising a knotter (46) and a knotter controller (47) for controlling the knotter, wherein upon the preselected number of the columns of the bales being positioned in the compression chamber, the knotter controller activates the knotter (46) to tie the preselected number of the columns of the bales together during the predetermined time period, to form the bale bundle in the compression chamber.

10. The system according to claim 9 in which the injector controller is configured to initiate the predetermined injection sequence during the predetermined time period.

11. The system according to claim 10 in which the injector (36) locates the preselected number of the bales in the column at least partially in the chute during the predetermined time period.

12. The system according to claim 1 additionally comprising a pick-up assembly for moving the respective bales on the ground to the table as the system moves in a forward direction relative to the ground, the pick-up assembly comprising:
a pair of walls defining a channel therebetween;
a pair of arms formed for guiding each said bale into a preselected orientation thereof and for guiding each said bale into the channel as the pick-up assembly moves forward relative to the ground;
a plurality of rollers defining respective axes thereof about which the rollers are rotatable, the rollers being positioned opposite to each other and mounted on resilient mount assemblies in the respective walls, each said roller at least partially extending beyond the wall in which the roller is mounted for engagement with each said bale to move each said bale along the channel; and
each said resilient mount assembly permitting outward movement of each said roller and urging inward movement of each said roller,
wherein the bales are individually engaged by the rotating rollers and thereby propelled along the channel, in succession.

13. A pick-up assembly for picking up bales from the ground individually and moving them to a predetermined destination location in a structure in a predetermined orientation while the pick-up assembly is moved forwardly relative to the ground, the pick-up assembly comprising:
a pair of walls defining a channel therebetween extending between an input end and an output end;
a pair of arms formed for guiding each said bale into a preselected orientation thereof and for guiding each said bale into the input end of the channel; and
a plurality of rollers defining respective axes thereof about which the rollers are respectively rotatable, the rollers being positioned opposite to each other and mounted on resilient mount assemblies in the respective walls, the resilient mount assemblies permitting outward movement of each said roller and urging inward movement of each said roller, each said roller being positioned for engagement with each said bale to move each said bale from the input end to the output end,
wherein, when the pick-up assembly moves in the forward direction, the bales are individually engaged by the rotating rollers in succession, to propel the bales along the channel to the output end, in succession.

14. A method of forming a bale bundle having a preselected number of columns of bales with preselected dimensions, each of the columns including a predetermined number of the bales, the method comprising:
(a) providing a body assembly (22) comprising an intake portion (24), a loading chamber (26), a compression chamber (28) in fluid communication with the loading chamber (26), the loading chamber (26) being formed to receive the predetermined number of the bales in each said column respectively, the compression chamber being partially defined by a floor (64) thereof and formed to receive the preselected number of the columns of the bales therein;
(b) providing an intake assembly (30) at least partially positioned in the intake portion (24), the intake assembly (30) comprising a table (32) on which each said bale is individually positioned at an engagement location, in succession;
(c) providing an injection assembly (34) comprising an injector (36) and an injection controller (40) for causing the injector to move the predetermined number of the bales individually in succession in a predetermined injection sequence from the engagement location into a chute (38) that is in fluid communication with the loading chamber (36);
(d) with the injector, upon the commencement of the predetermined injection sequence, moving a preselected number of the bales in the column into the chute (38), the preselected number of the bales being the predetermined number of bales in the column but one;
(e) with the injector, moving a final one of the predetermined number of the bales in the column into the chute, and pushing the predetermined number of the bales into the loading chamber; and
(f) with the injector, supporting the predetermined number of the bales in the column in the loading chamber.

15. The method according to claim 14 additionally comprising:
(g) providing a plunger assembly (42) comprising a plunger (44) and a plunger controller (48) configured to cause the plunger (44) to move the preselected number of the columns of the bales individually in succession from the loading chamber into the compression chamber in a predetermined assembly sequence;
(h) with the plunger, moving a predetermined number of the columns into the compression chamber, the predetermined number being the preselected number of the columns but one;
(i) with the plunger, moving a final one of the preselected number of the columns of the bales into the compression chamber; and
(j) with the plunger, compressing the preselected number of the columns of the bales in the compression chamber for a predetermined time period.

16. The method according to claim 15 additionally comprising:
(k) with a knotter, during the predetermined time period, tying the preselected number of the columns of the bales together, to form the bale bundle in the compression chamber.

17. The method according to claim 16 additionally comprising, with the injection controller, initiating the predetermined injection sequence during the predetermined time period.

18. The method according to claim 17 additionally comprising, with the injector, locating the preselected number of the bales in the chute.
